(19) United States
(12) Patent Application Publication
(10) Pub. No.: US 2024/0154666 A1
(43) Pub. Date: May 9, 2024

(54) POWER CONSTRAINT AWARE CHANNEL STATE INFORMATION FEEDBACK FOR COHERENT JOINT TRANSMISSION

(71) Applicant: QUALCOMM Incorporated, San Diego, CA (US)

(72) Inventors: Kiran Venugopal, Green Brook, NJ (US); Wooseok Nam, San Diego, CA (US); Mostafa Khoshnevisan, San Diego, CA (US); Tao Luo, San Diego, CA (US)

(21) Appl. No.: 18/054,093

(22) Filed: Nov. 9, 2022

(51) Int. Cl. H04B 7/06; H04B 7/0456; H04L 5/00

(52) U.S. Cl. CPC H04B 7/0626; H04B 7/0465; H04B 7/0639; H04L 5/0051

(57) ABSTRACT

Methods, systems, and devices for wireless communication are described. A UE may receive an indication of a set of one or more power constraints applicable to a network entity. The UE may receive a channel state information reference signal associated with one or more transmission and reception points of the network entity. The UE may select a plurality of precoding parameters (e.g., coherent joint transmission parameters) based on the set of one or more power constraints. The UE may transmit a channel state information report to the network entity indicating a set of one or more codebooks for one or more coherent joint transmissions received at the UE in accordance with the set of one or more power constraints, where set of one or more the codebooks may indicate the plurality of precoding parameters.

### FIELD OF TECHNOLOGY

The following relates to wireless communication, including power constraint aware channel state information feedback for coherent joint transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support power constraint aware channel state information feedback for coherent joint transmission. For example, the described techniques provide for a user equipment (UE) to receive an indication of a set of one or more power constraints applicable to a network entity. The UE may receive a channel state information reference signal associated with one or more transmission and reception points of the network entity. The UE may select a plurality of precoding parameters (e.g., coherent joint transmission parameters) based on the set of one or more power constraints. The UE may transmit a channel state information report to the network entity indicating a set of one or more codebooks for one or more coherent joint transmissions received at the UE in accordance with the set of one or more power constraints, where set of one or more the codebooks may indicate the plurality of precoding parameters.

An apparatus for wireless communication at a UE is described. The apparatus may include a processor, memory coupled with the processor, and instructions stored in the memory. The instructions may be executable by the processor to cause the apparatus to receive an indication of a set of one or more power constraints applicable to a network entity, receive a channel state information reference signal associated with one or more transmission and reception points of the network entity, and transmit, to the network entity, a channel state information report indicating a set of one or more codebooks for one or more coherent joint transmissions received at the UE in accordance with the set of one or more power constraints.

A method for wireless communication at a UE is described. The method may include receiving an indication of a set of one or more power constraints applicable to a network entity, receiving a channel state information reference signal associated with one or more transmission and reception points of the network entity, and transmitting, to the network entity, a channel state information report indicating a set of one or more codebooks for one or more coherent joint transmissions received at the UE in accordance with the set of one or more power constraints.

Another apparatus for wireless communication at a UE is described. The apparatus may include means for receiving an indication of a set of one or more power constraints applicable to a network entity, means for receiving a channel state information reference signal associated with one or more transmission and reception points of the network entity, and means for transmitting, to the network entity, a channel state information report indicating a set of one or more codebooks for one or more coherent joint transmissions received at the UE in accordance with the set of one or more power constraints.

A non-transitory computer-readable medium storing code for wireless communication at a UE is described. The code may include instructions executable by a processor to receive an indication of a set of one or more power constraints applicable to a network entity, receive a channel state information reference signal associated with one or more transmission and reception points of the network entity, and transmit, to the network entity, a channel state information report indicating a set of one or more codebooks for one or more coherent joint transmissions received at the UE in accordance with the set of one or more power constraints.

Some examples of the method, apparatuses, and non-transitory computer-readable medium described herein may further include operations, features, means, or instructions for selecting a set of multiple precoding parameters associated with the set of one or more power constraints, where the set of one or more codebooks indicates the set of multiple precoding parameters.

In some examples of the method, apparatuses, and non-transitory computer-readable medium described herein, receiving the channel state information reference signal may include operations, features, means, or instructions for measuring the channel state information reference signal, where selecting the set of multiple precoding parameters may be in accordance with the measuring.

Some examples of the method, apparatuses, and non-transitory computer-readable medium described herein may further include operations, features, means, or instructions for generating a set of multiple coherent joint transmission precoding parameters corresponding to each power constraint of the set of one or more power constraints, where the set of multiple precoding parameters includes the set of multiple coherent joint transmission precoding parameters.

In some examples of the method, apparatuses, and non-transitory computer-readable medium described herein, the set of one or more power constraints indicates at least one of a power limit per transmission and reception point, an average power limit for the one or more transmission and reception points, or a total power limit for the one or more transmission and reception points.

Some examples of the method, apparatuses, and non-transitory computer-readable medium described herein may further include operations, features, means, or instructions for receiving a message indicating a power constraint of the set of one or more power constraints, where the set of one or more codebooks includes a codebook associated with the power constraint based on the message indicating the power constraint.

In some examples of the method, apparatuses, and non-transitory computer-readable medium described herein, the set of one or more power constraints may be associated with a time duration, a bandwidth, a spatial domain, or any combination thereof.

In some examples of the method, apparatuses, and non-transitory computer-readable medium described herein, the set of one or more power constraints may be associated with a cell, a bandwidth part, one or more resources, a synchronization signal block, a transmission and reception point, one or more transmission configuration indicators, or any combination thereof.

Some examples of the method, apparatuses, and non-transitory computer-readable medium described herein may further include operations, features, means, or instructions for receiving an indication of the set of one or more codebooks, each codebook of the set of one or more codebooks associated with a respective power constraint of the set of one or more power constraints, where transmitting the channel state information report may be based on receiving the indication of the set of one or more codebooks.

Some examples of the method, apparatuses, and non-transitory computer-readable medium described herein may further include operations, features, means, or instructions for receiving a medium access control-control message indicating the set of one or more power constraints and one or more activation signals for the UE.

In some examples of the method, apparatuses, and non-transitory computer-readable medium described herein, the one or more activation signals indicate an activation of one or more transmission configuration indicator states, one or more resources, one or more component carriers, or a combination thereof.

Some examples of the method, apparatuses, and non-transitory computer-readable medium described herein may further include operations, features, means, or instructions for receiving, from the network entity, a downlink control information message indicating the set of one or more power constraints.

In some examples of the method, apparatuses, and non-transitory computer-readable medium described herein, the downlink control information message may be associated with an aperiodic reference signal, an aperiodic channel state information report, a dynamic grant, or a beam indication.

An apparatus for wireless communication at a network entity is described. The apparatus may include a processor, memory coupled with the processor, and instructions stored in the memory. The instructions may be executable by the processor to cause the apparatus to transmit, to a UE, an indication of a set of one or more power constraints applicable to the network entity, transmit a channel state information reference signal associated with one or more transmission and reception points of the network entity, and receive, from the UE, a channel state information report indicating a set of one or more codebooks for one or more coherent joint transmissions associated with the UE in accordance with the set of one or more power constraints.

A method for wireless communication at a network entity is described. The method may include transmitting, to a UE, an indication of a set of one or more power constraints applicable to the network entity, transmitting a channel state information reference signal associated with one or more transmission and reception points of the network entity, and receiving, from the UE, a channel state information report indicating a set of one or more codebooks for one or more coherent joint transmissions associated with the UE in accordance with the set of one or more power constraints.

Another apparatus for wireless communication at a network entity is described. The apparatus may include means for transmitting, to a UE, an indication of a set of one or more power constraints applicable to the network entity, means for transmitting a channel state information reference signal associated with one or more transmission and reception points of the network entity, and means for receiving, from the UE, a channel state information report indicating a set of one or more codebooks for one or more coherent joint transmissions associated with the UE in accordance with the set of one or more power constraints.

A non-transitory computer-readable medium storing code for wireless communication at a network entity is described. The code may include instructions executable by a processor to transmit, to a UE, an indication of a set of one or more power constraints applicable to the network entity, transmit a channel state information reference signal associated with one or more transmission and reception points of the network entity, and receive, from the UE, a channel state information report indicating a set of one or more codebooks for one or more coherent joint transmissions associated with the UE in accordance with the set of one or more power constraints.

In some examples of the method, apparatuses, and non-transitory computer-readable medium described herein, the set of one or more codebooks indicates a set of multiple coherent joint transmission precoding parameters.

In some examples of the method, apparatuses, and non-transitory computer-readable medium described herein, a power limit per transmission and reception point, an average power limit for the one or more transmission and reception points, or a total power limit for the one or more transmission and reception points.

Some examples of the method, apparatuses, and non-transitory computer-readable medium described herein may further include operations, features, means, or instructions for transmitting, to the UE, a message indicating a power constraint of the set of one or more power constraints, where the set of one or more codebooks includes a codebook associated with the power constraint based on the message indicating the power constraint.

Some examples of the method, apparatuses, and non-transitory computer-readable medium described herein may further include operations, features, means, or instructions for transmitting an indication of the set of one or more codebooks, each codebook of the set of one or more codebooks associated with a respective power constraint of the set of one or more power constraints, where transmitting the channel state information report may be based on transmitting the indication of the set of one or more codebooks.

Some examples of the method, apparatuses, and non-transitory computer-readable medium described herein may further include operations, features, means, or instructions for transmitting a medium access control-control message indicating the set of one or more power constraints and one or more activation signals for the UE.

In some examples of the method, apparatuses, and non-transitory computer-readable medium described herein, the one or more activation signals indicate an activation of one or more transmission configuration indicator states, one or more resources, one or more component carriers, or a combination thereof.

Some examples of the method, apparatuses, and non-transitory computer-readable medium described herein may further include operations, features, means, or instructions for transmitting, to the UE, a downlink control information message indicating the set of one or more power constraints.

In some examples of the method, apparatuses, and non-transitory computer-readable medium described herein, the downlink control information message may be associated with an aperiodic reference signal, an aperiodic channel state information report, a dynamic grant, or a beam indication.

In some examples of the method, apparatuses, and non-transitory computer-readable medium described herein, the set of one or more power constraints may be associated with a time duration, a bandwidth, a spatial domain, or any combination thereof.

In some examples of the method, apparatuses, and non-transitory computer-readable medium described herein, the set of one or more power constraints may be associated with a cell, a bandwidth part, one or more resources, a synchronization signal block, a transmission and reception point, one or more transmission configuration indicators, or any combination thereof.

### BRIEF DESCRIPTION OF THE DRAWINGS

FIG. 1 illustrates an example of a wireless communications system that supports power constraint aware channel state information feedback for coherent joint transmission in accordance with one or more aspects of the present disclosure.

FIG. 2 illustrates an example of a wireless communications system that supports power constraint aware channel state information feedback for coherent joint transmission in accordance with one or more aspects of the present disclosure.

FIG. 3 illustrates an example of a wireless communications system that supports power constraint aware channel state information feedback for coherent joint transmission in accordance with one or more aspects of the present disclosure.

FIG. 4 illustrates an example of a process flow that supports power constraint aware channel state information feedback for coherent joint transmission in accordance with one or more aspects of the present disclosure.

FIGS. 5 and 6 illustrate block diagrams of devices that support power constraint aware channel state information feedback for coherent joint transmission in accordance with one or more aspects of the present disclosure.

FIG. 7 illustrates a block diagram of a communications manager that supports power constraint aware channel state information feedback for coherent joint transmission in accordance with one or more aspects of the present disclosure.

FIG. 8 illustrates a diagram of a system including a device that supports power constraint aware channel state information feedback for coherent joint transmission in accordance with one or more aspects of the present disclosure.

FIGS. 9 and 10 illustrate block diagrams of devices that support power constraint aware channel state information feedback for coherent joint transmission in accordance with one or more aspects of the present disclosure.

FIG. 11 illustrates a block diagram of a communications manager that supports power constraint aware channel state information feedback for coherent joint transmission in accordance with one or more aspects of the present disclosure.

FIG. 12 illustrates a diagram of a system including a device that supports power constraint aware channel state information feedback for coherent joint transmission in accordance with one or more aspects of the present disclosure.

FIGS. 13 through 17 illustrate flowcharts showing methods that support power constraint aware channel state information feedback for coherent joint transmission in accordance with one or more aspects of the present disclosure.

### DETAILED DESCRIPTION

Some wireless communications systems may support joint transmissions to a user equipment (UE), which may include coherent joint transmission and non-coherent joint transmission. For example, a network entity may perform data transmissions (e.g., concurrently) from multiple transmission points (e.g., access points (APs), transmission and reception points (TRPs), or other network entities) to a UE. In some examples, a network entity may transmit a message to a UE via multiple TRPs, each TRP using a different channel associated with respective analog precoders and digital precoders. Further, the network entity may transmit according to one or more power constraints (e.g., associated with the multiple TRPs), and the UE may not be aware of the one or more power constraints. For example, the network entity may have a total power constraint imposed (e.g., to itself or by another network entity), a power constraint per TRP, or an average power limit per TRP, among other examples.

The UE may select parameters (e.g., coherent joint transmission coefficients or weights) for joint transmissions from the network entity via one or more transmission points based on channel measurements, and the UE may report or request the selected parameters to the network entity. For example, the UE may select parameters for a joint transmission and transmit a report requesting the network entity to use the selected parameters for the joint transmission. The network entity may evaluate the report and may decide parameters for the joint transmission based on the parameters requested by the UE. As the UE is unaware of the one or more power constraints, however, the parameters requested by the UE may cause a violation of a power constraint applicable to the network entity. In these cases, the network entity may decide to back off and not perform the transmissions that would cause the power constraint violation. This may increase latency and incur additional overhead, even if it would have been possible for the UE to select or request transmission parameters that would have satisfied the power constraints at the network entity.

In accordance with examples as described herein, a network entity may transmit an indication of one or more power constraints applicable to the network entity to a UE. For example, the network entity may indicate the UE of a maximum power limit per TRP, an average power limit over a set of TRPs, a total (e.g., sum) power limit over a set of TRPs, a limit to a ratio between parameters selected by the UE, another power constraint, or a combination thereof. The UE may select one or more parameters (e.g., coherent joint transmission weights) in accordance with the indicated one or more power constraints and based on measurements performed by the UE. The UE may report (e.g., in a channel state information (CSI) report) the one or more parameters to the network entity (e.g., as precoding matrix indicators (PMIs)). In some examples, the network entity may configure the UE with one or more codebooks that correspond to one or more power constraints of the one or more power constraints, and the UE may determine the one or more parameters for one or more of the codebooks. The UE may transmit the report to the network entity including one or more of the codebooks, which may indicate the one or more parameters selected according to the indicated one or more power constraints.

Aspects of the disclosure are initially described in the context of wireless communications systems. Aspects of the disclosure are additionally described in the context of process flows. Aspects of the disclosure are further illustrated by and described with reference to apparatus diagrams, system diagrams, and flowcharts that relate to power constraint aware CSI feedback for coherent joint transmission.

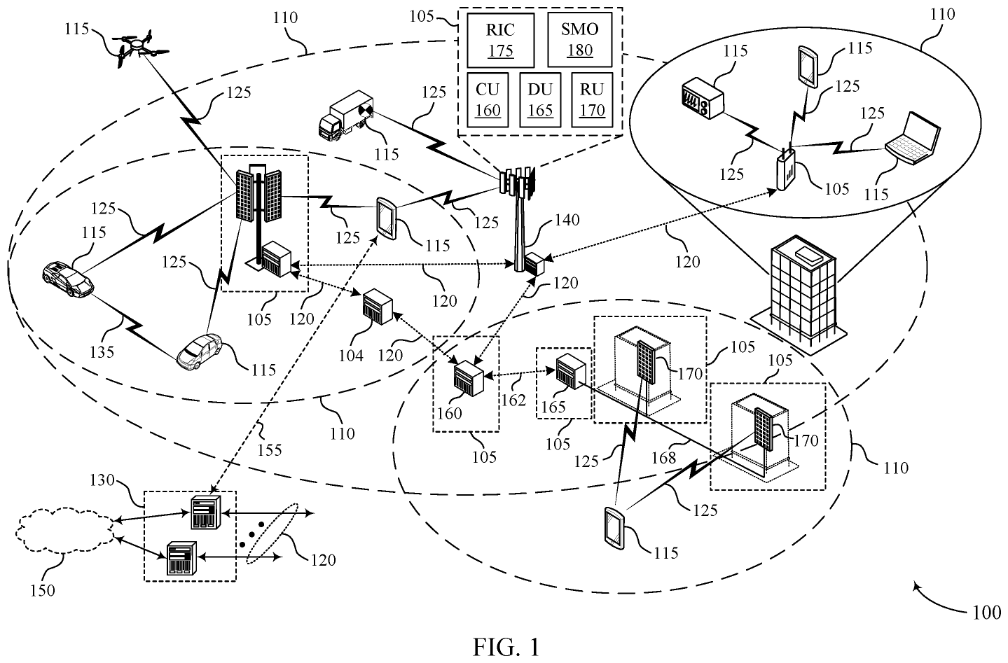

FIG. 1 illustrates an example of a wireless communications system 100 that supports power constraint aware CSI feedback for coherent joint transmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an AP, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support power constraint aware CSI feedback for coherent joint transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support one or more codebooks (e.g., Type-II codebooks) that may be used for reporting CSI. For example, a codebook may be used (e.g., at a network entity 105 and a UE 115) to determine a size of a precoding matrix that may be used at the network entity 105 for precoding transmissions, such as MIMO transmissions using one or multiple data streams (e.g., one or multiple layers (l)). In some examples, the size (e.g., dimensions) of the precoding matrix may depend on a quantity of antennas (e.g., transmit antennas at the network entity 105 or a TRP performing the transmission) and a quantity of precoding matrices (e.g., a quantity of PMI) configured at the network entity 105. Additionally, or alternatively, a quantity of layers (1) used at the network entity 105 (e.g., for a downlink transmission) may be configured at the UE 115 (e.g., via signaling from the network entity 105, such as RRC signaling). In some examples, the size of the precoding matrix may be determined in accordance with the following Equation 1:

Nₜ×N₃ (1)

in which Nₜ may correspond to the quantity of antennas (e.g., transmit antenna ports at the network entity 105 or a TRP associated with the network entity 105) and N₃ may correspond to the quantity of PMI (e.g., a quantity of radio frequency spectrum bands the network entity 105 may precode over).

In some examples, the quantity of PMI may be determined (e.g., at the network entity 105) based on a quantity of channel quality indicator (CQI) sub-bands and a quantity of PMI sub-bands (e.g., per CQI sub-band). In some examples, a CQI sub-band (or a PMI sub-band) may correspond to a portion of a bandwidth represented by the reported CQI (or PMI). In some examples, the quantity of CQI sub-bands and the quantity of PMI sub-bands may be configured at the UE 115 (e.g., via signaling from the network entity 105, such as RRC signaling).

In some examples, for transmit layer (l), the precoding matrix (e.g., a compressed Type II precoder (W^{(l)})) may exploit a sparsity of the spatial domain and the frequency domain. For example, a CSI formula for a Type II codebook may be used to indicate the precoding matrix using a structure described in accordance with Equation 2:

W^{(l)}=W₁W_{2,l}W_{f,l}^{H} (2)

in which W^{(l)} may represent the precoding matrix, W₁ may represent a spatial domain basis function (e.g., a discrete Fourier transform (DFT) function), W_{2,l} may represent channel coefficients (e.g., spatial frequency domain channel coefficients), and W_{f}^{H} may represent frequency domain basis functions (e.g., a DFT function).

In some cases, the spatial domain basis functions (e.g., a spatial domain precoder represented using the matrix W₁) may include spatial domain basis functions that consider (e.g., include, account for) a quantity of beams (L) (e.g., to be used at the network entity 105). That is, the matrix W₁ may include a quantity of spatial domain basis functions that may be based on (e.g., correspond to) a quantity of beams (L) at the network entity 105 or an associated TRP. For example, the spatial domain basis functions may include a quantity of columns (L) per polarization group (e.g., about 2 L beams). In some examples, the spatial domain basis functions (e.g., the matrix W₁) may be common to multiple layers (l). That is, for some transmissions (e.g., multi-stream MIMO transmissions) a same set of spatial domain basis functions may be used for multiple (e.g., each) layer (l). In some examples, the size of the spatial domain basis functions (e.g., basis vectors in the spatial domain, DFT basis vectors) may be represented in accordance with the following Equation 3:

Nₜ×2L (3)

in which L beams may be selected (e.g., at the network entity 105) for each polarization group. Additionally, or alternatively, the parameter L may be configured at the UE 115 (e.g., via signaling from the network entity 105, such as via RRC signaling). In some examples, CSI reported from the UE 115 to the network entity 105 may be based on the parameter L (e.g., and one or more other parameters to be used for the downlink transmission, such as the quantity of CQI sub-bands, the quantity of PMI sub-bands and the quantity of layers (l)).

In some examples, the channel coefficients (e.g., represented using the matrix W_{2,l}) may include a combination of coefficients (e.g., amplitude and co-phasing coefficients), in which an entry (e.g., (m, n)) may be a linear combination coefficient associated with an (e.g., m^{th}) spatial domain basis vector and an (e.g., n^{th}) frequency domain basis vector. Additionally, or alternatively, channel coefficients (e.g., the matrix W_{2,l}) may be layer-specific. That is, for some transmissions (e.g., multi-stream MIMO transmissions), multiple (e.g., different) sets of channel coefficients may be used for multiple (e.g., different) layers (l). In some examples, such as for a Type II precoding matrix composition for layer (l), a row of the matrix W_{2,l} may correspond to a spatial beam in the matrix W₁ and an entry (e.g., of the matrix W_{2,l}) may represent the coefficient of a tap for the spatial beam. As such, a size of the coefficient matrix W_{2,l}, (e.g., the channel coefficients) may be represented in accordance with Equation 4:

2L×M (4)

in which the parameter 2 L may correspond to the quantity of spatial domain basis functions and the parameter M may correspond to the quantity of frequency domain basis functions. That is, columns of the matrix W_{2,l}, may correspond to the frequency domain basis functions and rows of the matrix W_{2,l}, may correspond to the spatial domain basis functions.

In some cases, the parameter M may be configured (e.g., RRC configured) at the network entity 105 and the UE 115. For example, the network entity may indicate the parameter M to the UE 115 via RRC signaling. Additionally, or alternatively, M may be based on (e.g., may be a function of) a rank indicator (RI). Additionally, or alternatively, the channel coefficients (e.g., represented using the matrix W_{2,l}, which may include 2 L×M elements) may include a quantity (e.g., a maximum quantity or an otherwise suitable quantity) of non-zero coefficients (e.g., K₀ non-zero coefficients for a layer and 2K₀ non-zero coefficients for multiple layers). That is, for a single layer the UE 115 may report K₀ non-zero coefficients and across multiple (e.g., all) layers the UE 115 may report 2K₀ non-zero coefficients (e.g., within the channel coefficients) to the network entity 105.

In some examples, an entry in the matrix W_{2,l} may correspond to a row of the matrix W_{f,l}^{H}. For example, the frequency domain basis functions may include basis vectors (e.g., basis vectors in the frequency domain, discrete Fourier transform basis vectors) used to perform compression in the frequency domain. That is, each row of the matrix W_{f,l}^{H} may correspond to a basis vector. Additionally, or alternatively, the frequency domain basis functions (e.g., represented using the matrix W_{f,l}^{H}) may be layer-specific. That is, for some transmissions (e.g., multi-stream MIMO transmissions), multiple (e.g., different) sets of frequency domain basis functions may be used for multiple (e.g., different) layers (l). In some examples, a size of the frequency domain basis functions may be represented in accordance with the following Equation 5:

M×N₃. (5)

The wireless communications system 100 may support joint transmissions to a UE 115, which may include coherent joint transmission and non-coherent joint transmission. For example, a network entity 105 may perform data transmissions (e.g., concurrently) from multiple transmission points (e.g., APs, TRPs, or other network entities 105) to a UE 115. In some examples, a network entity 105 may transmit a message to a UE 115 via multiple TRPs, and each TRP may use a different channel associated with respective analog precoders and digital precoders. Further, the network entity 105 may transmit according to one or more power constraints (e.g., associated with the multiple TRPs), and the UE 115 may be unaware of the one or more power constraints. For example, the network entity may have a total power constraint imposed (e.g., to itself or by another network entity), a power constraint per TRP, or an average power limit per TRP, among other examples.

In some examples, the UE 115 may select parameters (e.g., coherent joint transmission coefficients or weights) for joint transmissions from the network entity 105 via one or more transmission points based on channel measurements, and the UE 115 may report the selected parameters to the network entity 105. As the UE 115 is unaware of the one or more power constraints, however, the selected parameters may cause a violation of a power constraint applicable to the network entity. In these cases, the network entity may decide to back off and not perform the transmissions that would cause the power constraint violation. This may increase latency and incur additional overhead, even if there were parameters that the UE 115 may have selected that would have satisfied the power constraints at the network entity.

In accordance with examples as described herein, a network entity 105 may transmit an indication to a UE 115 of one or more power constraints applicable to the network entity 105. For example, the network entity may indicate to the ULE 115 a maximum power limit per TRP, an average power limit over a set of TRPs, a total (e.g., sum) power limit over a set of TRPs, a limit to a ratio between parameters selected by the UE 115, another power constraint, or a combination thereof. The UE 115 may select one or more parameters (e.g., coherent joint transmission weights) in accordance with the indicated one or more power constraints and based on measurements performed by the UE 115. The UE 115 may report (e.g., in a channel state information (CSI) report) the one or more parameters to the network entity 105 (e.g., as precoding matrix indicators (PMIs)). In some examples, the network entity 105 may configure the UE 115 with one or more codebooks that correspond to one or more power constraints of the one or more power constraints, and the UE 115 may determine the one or more parameters for one or more of the codebooks. The UE 115 may transmit the report to the network entity 105 including one or more of the codebooks, which may indicate the one or more parameters selected according to the indicated one or more power constraints. The network entity 105 may use all or a portion of the one or more parameters reported by the UE 115 in future transmissions to the UE 115.

Accordingly, the UE 115 may determine one or more precoding parameters in accordance with the one or more power constraints applicable to the network entity 105. Thus, the UE 115 and the network entity 105 may avoid precoding parameters that cause a violation of the one or more power constraints applicable to the network entity 105, for example, which may decrease latency and improve connection stability at the UE 115.

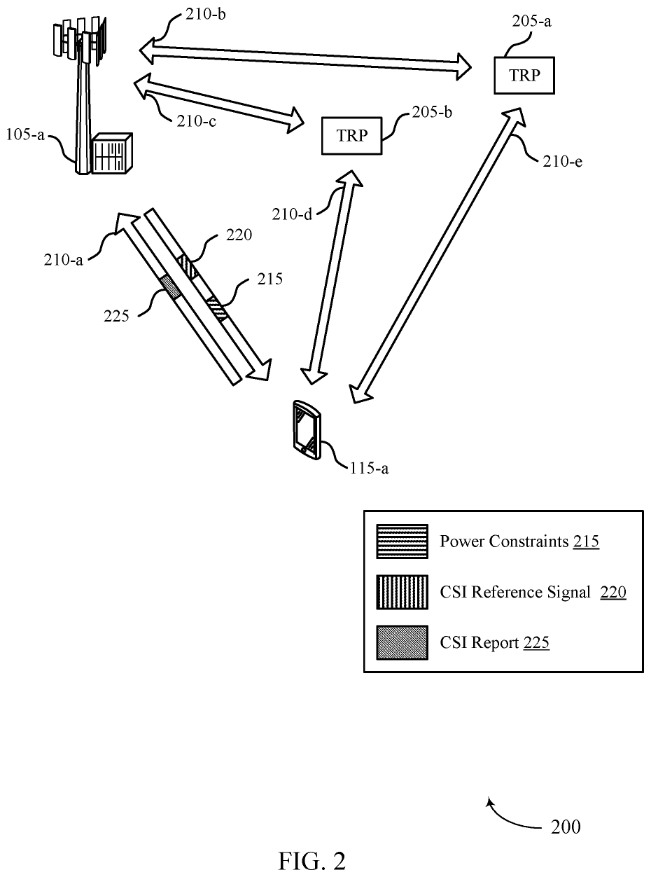

FIG. 2 illustrates an example of a wireless communications system 200 that supports power constraint aware CSI feedback for coherent joint transmission in accordance with one or more aspects of the present disclosure. The wireless communications system 200 may implement or be implemented in wireless communications system 100, as described herein with reference to FIG. 1. For example, the wireless communications system 200 may illustrate communications between a UE 115-a, a network entity 105-a, a TRP 205-a, and a TRP 205-b, which may be examples of corresponding devices as described herein, with reference to FIG. 1.

The devices illustrated within wireless communications system 200 may communicate via a communication link 210-a, a communication link 210-b, a communication link 210-c, a communication 210-d, or a communication link 210-e, which may be examples of communication links 125 as described herein with reference to FIG. 1.

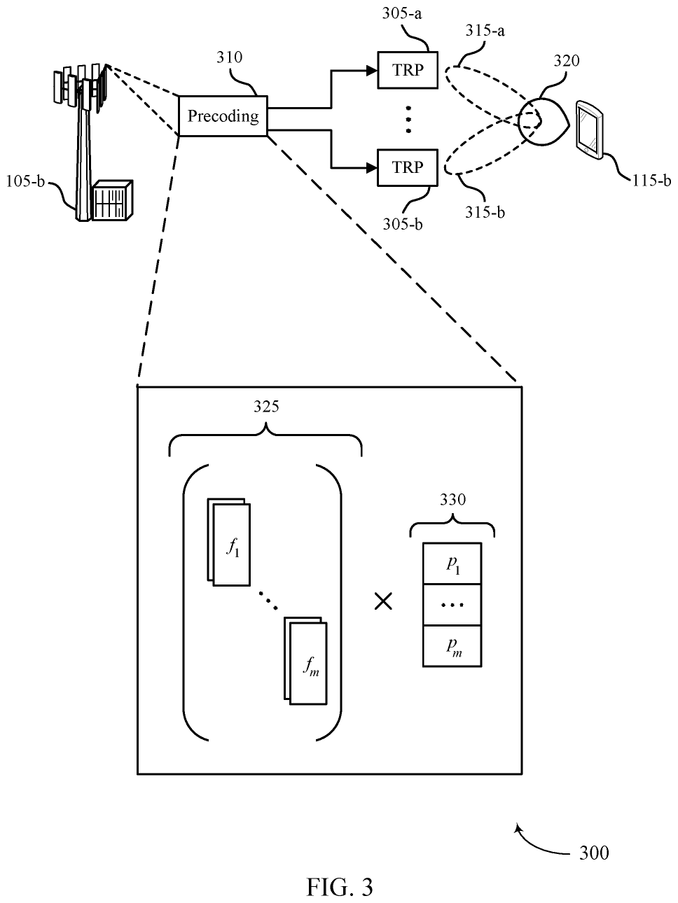

The wireless communications system 200 may support coherent joint transmissions from the network entity 105-a to the UE 105-a, as described herein with reference to FIG. 1. For example, the network entity 105-a precode the TRP 205-a and the TRP 205-b (e.g., via communication link 210-b and communication link 210-c, respectively) to perform transmissions to the UE 105-a via communication link 210-d and communication link 210-e, respectively. In some examples, the network entity 105-a may precode the TRP 205-a and the TRP 205-b in accordance with precoding parameters (e.g., preferred precoders parameters) indicated (e.g., requested) by the UE 115-a, which may include coherent joint transmission parameters (e.g., combining weights, beams, or other parameters). The precoding of TRPs 205 by a network entity 105 and the selection of (e.g., optimal or appropriate) coherent joint transmission parameters are described in further detail herein, with reference to FIG. 3.

In some cases, the network entity 105-a may be subject to one or more power constraints. For example, the network entity 105-a may be subject to a total power constraint or one or more power constraints per TRP 205. In some examples, the (e.g., optimal or appropriate) coherent joint transmission parameters may be based on the one or more power constraints applicable to the network entity 105-a. The UE 115-a may be unaware of the one or more power constraints applicable to the network entity 105-a, however, and the UE 115-a may select coherent joint transmission parameters that may cause a violation of the one or more power constraints at the network entity 105-a. The network entity 105-a may determine to back off from performing the joint transmission based on the power constraint violation, which may increase latency and incur additional overhead during retransmissions.

In accordance with examples as described herein, the network entity 105-a may transmit a message (e.g., via communication link 210-a) containing an indication of a set of one or more power constraints 215 applicable to the network entity 105-a. For example, the network entity 105-a may indicate the UE 115-a of a power limit per TRP 205, an average power limit for each of the TRP 205-a and the TRP 205-b, a total power limit (e.g., for each of the TRP 205-a and the TRP 205-b), a limit between a highest coherent joint transmission coefficient

$$( e . g . , {max}_{k} {\vert {p}_{k} \vert}^{2}$$

where pₖ is a coefficient for a TRP 205, for a quantity of k TRPs 205) and an average coefficient (e.g., average |pₖ|²), or a combination thereof. In some cases, the one or more power constraints 215 may be based on a time duration (e.g., a quantity of slots), a bandwidth, or on a spatial domain.

In some cases, the network entity 105-a may be subject to one or more power constraints 215 for antenna ports of a single TRP 205. For example, the one or more power constraints 215 may include a power limit per antenna port of the TRP 205-a, an average power limit for each antenna port of the TRP 205-a, or a total power limit for all antenna ports of the TRP 205-a.

In some examples, the network entity 105-a may transmit the indication of the one or more power constraints 215 as part of a configuration. The configuration may be transmitted or may be valid per cell, per bandwidth part, per resource set, per resource, per group of transmission configuration indicators (TCIs), per synchronization signal block (SSB), or per TRP, among other examples. Additionally, or alternatively, the network entity 105-a may indicate the one or more power constraints 215 via a MAC-control element (MAC-CE) message alongside one or more activation signals for activating one or more TCI states, component carriers, or resource sets. Additionally, or alternatively, the network entity 105-a may indicate the one or more power constraints 215 via a downlink control information (DCI) message.

In some examples, the UE 115-a may be configured (e.g., by the network entity 105-a) with one or more codebooks for one or more coherent joint transmissions to be received at the UE 115-a. For example, the network entity 105-a may configure the UE 115-a with the one or more codebooks alongside the indication of the one or more power constraints 215.

In some cases, the one or more codebooks may correspond to one or more of the power constraints 215. For example, the network entity 105-a may configure the UE 115-a with a codebook corresponding to a power limit per TRP 205, an average power limit for each of the TRP 205-a and the TRP 205-b, a total power limit, a limit between a highest coherent joint transmission coefficient

$$( e . g . , {max}_{k} {\vert {p}_{k} \vert}^{2} )$$

and an average coefficient (e.g., average |pₖ|²), or any combination thereof.

The network entity 105-a may transmit a CSI-RS to the UE 115-a, and the UE 115-a may measure the CSI-RS to obtain channel measurements. In some examples, the network entity 105-a may transmit a CSI-RS from one or more TRPs 205. For example, the network entity 105-a may transmit one or more CSI-RSs to the UE 115-a from the TRP 205-a and the TRP 205-b via communication link 210-d and communication link 210-e, respectively.

The UE 115-a may select precoding parameters (e.g., coherent joint transmission parameters) in accordance with the one or more power constraints 215 and based on, for example, the channel measurements (e.g., a reference signal received power (RSRP)) obtained from measuring a received CSI-RS. The selection of the precoding parameters is described in more detail herein, with reference to FIG. 3.

In some examples, the UE 115-a may select precoder parameters associated with one or more of the codebooks for the one or more coherent joint transmissions to be received at the UE 115-a. In some cases, the network entity 105-a may transmit an indication of one or more of the codebooks, and the UE 115-a may select precoder parameters for the one or more indicated codebooks. The selection of one or more of the codebooks may be based on a type of the one or more power constraints 215 indicated to the UE 115-a. Additionally, or alternatively, the network entity 105-a may transmit an indication of one or more of the power constraints 215, and the UE 115-a may select power parameters for the codebooks associated with the one or more indicated power constraints 215.

The UE 115-a may transmit a CSI report 225 indicating the one or more precoder parameters. In some examples, the UE 115-a may report the one or more precoder parameters as PMIs. Additionally, or alternatively, the UE 115-a may transmit a CSI report 225 indicating one or more codebooks for the one or more coherent joint transmissions to be received at the UE 115-a, and the one or more codebooks may indicate the one or more precoder parameters selected in accordance with the one or more power constraints 215. In some cases, the UE 115-a may transmit the CSI report 225 indicating one or more precoder parameters associated with one or more indicated power constraints 215. For example, the CSI report 225 may indicate one or more codebooks (e.g., that indicate one or more precoder parameters) associated with power constraints 215 that were indicated as active (e.g., in a current time or slot, bandwidth, or spatial domain) by the network entity 105-a.

Accordingly, the UE 115-a may determine one or more precoding parameters in accordance with the one or more power constraints 215 applicable to the network entity 105. The network entity 105 may use all or a portion of the one or more precoding parameters determined by the UE 115-a in future transmissions to the UE 115-a. Thus, the UE 115-a and the network entity 105-a may avoid precoding parameters that cause a violation of the one or more power constraints 215 applicable to the network entity 105-a, for example, which may decrease latency and improve connection stability at the UE 115-a.

FIG. 3 illustrates an example of a wireless communications system 300 that supports power constraint aware CSI feedback for coherent joint transmission in accordance with one or more aspects of the present disclosure. The wireless communications system 300 may implement or be implemented in wireless communications system 100 and wireless communications system 200, as described herein with reference to FIGS. 1 and 2. For example, the wireless communications system 300 may illustrate communications between a UE 115-b, a network entity 105-b, a TRP 305-a, and a TRP 305-b, which may be examples of corresponding devices as described herein, with reference to FIGS. 1 and 2.

In some examples, the wireless communications system 300 may support joint transmissions to the UE 115-b, which may include coherent joint transmission and non-coherent joint transmission, as described herein with reference to FIGS. 1 and 2. For example, the network entity 105-b may perform data transmissions (e.g., concurrently) from multiple transmission points (e.g., APs, TRPs 305, or other network entities 105) to the UE 115-b. In some examples, the network entity 105-b may transmit a message to the UE 115-b via multiple TRPs 305 (e.g., up to four TRPs, in some implementations) and each TRP 305 may transmit according to a respective channel 315 associated with respective analog precoders and digital precoders. For example, the network entity 105-b may perform a coherent joint transmission from the TRP 305-a via a channel 315-a and from the TRP 305-b via a channel 315-b to the UE 115-b.

In some cases involving multi-TRP (e.g., m-TRP) transmissions, each TRP 305 involved in a transmission may use a codebook (e.g., a Type II codebook) for CSI reporting, as described herein with reference to FIG. 1. In some examples, each TRP 305 involved in a joint transmission may be co-located (e.g., quasi co-located). Additionally, or alternatively, each TRP 305 involved in the joint transmission may undergo precoding 310 (e.g., joint precoding), which may be performed by the network entity 105-b. For example, each TRP 305 involved in the joint transmission may be connected to the network entity 105-b (e.g., via a backhaul communication link), and the network entity 105-b may jointly precode each TRP 305. The precoding 310 may involve analog precoding 325, and digital precoding 330.

In some examples, each TRP 305 may be associated with a respective channel 315 for communication with the UE 115-b that is to receive the joint transmission. For example, the TRP 305-a may be associated with a channel 315-a (e.g., a channel Hₐ) between the TRP 305-a and the UE 115-b, and the TRP 305-b may be associated with have a channel 315-b (e.g., a channel H_{b}) between the TRP 305-b and the UE 115-b. In some examples, the UE 115-b may perceive a single effective channel 320, and the effective channel may be a combination of each channel associated with each TRP 305 involved in the joint transmission.

Accordingly, for a given layer and time and frequency resource, a coherent joint transmission precoder may be a product of an analog (e.g., spatial domain) precoder, which may be a matrix containing transmit beams corresponding to each TRP 305, and a digital (e.g., coefficient matrix) precoder, which may be a 1-dimensional matrix containing a coherent joint transmission coefficient associated with each TRP 305.

In some examples, the network entity 105-b may perform coherent joint transmission procedures transmit according to one or more power constraints. For example, a total power constraint may be imposed on the network entity 105-b. In some cases, assuming that the analog precoder (e.g., fₖ) is normalized (e.g., the norm of the analog precoder is 1) so that power constraints on the coherent joint transmission precoders are captured via the digital precoder, then a total power constraint for a quantity of TRPs 305 given by k may be described by Equation 6:

Σₖ|pₖ|²≤s (6)

in which pₖ represents a coefficient (e.g., a coherent joint transmission coefficient) associated with a TCI state k corresponding to a TRP 305 with index k, and s represents the total power constraint.

In some cases, the total power constraint at the network entity 105-b may result in a power imbalance. For example, most of the power may be used in a transmission by a single TRP 305 of the multiple TRPs 305 involved in a joint transmission. This power imbalance may be present in single TRP 305 transmissions, however, in single TRP 305 transmissions, each antenna port of the TRP 305 may have a same large-scale fading, and a precoder used for the transmission may eventually distribute power across each antenna relatively evenly. In the multi-TRP 305 case, however, the large-scale fading of each antenna may be different, and a precoder may not evenly distribute power across the antennas.

In a multi-TRP transmission involving the TRP 305-a and the TRP 305-b, the TRP 305-a may be associated with a first TCI state, and the TRP 305-b may be associated with a second TCI state. The TCI states may be selected by the network entity 105-b using a group-based beam management framework and a same reception spatial filter for joint (e.g., simultaneous) reception. In this case, an RSRP of a TCI with index k (e.g., TCI-k) may be given by Equation 7:

rₖ=∥wHₖfₖ∥² (7)

in which rₖ represents the RSRP of TCI-k, Hₖ is the channel associated with a TRP 305-k (e.g., the TRP 305 corresponding to TCI-k), fₖ denotes a transmit beam associated with the TRP 305-k, and w represents a receiver beamforming parameter associated with the UE 115-b (e.g., determined by the UE 115-b). The beamformed channel between the TRP 305-k and the UE 115-b may correspond to wHₖfₖ, and may be denoted as given below in Equation 8:

$$w {H}_{k} {f}_{k} = \sqrt{{r}_{k}} {e}^{j θ k} \qquad ( 8 )$$

where θₖ represents a phasing angle (e.g., a phase of the complex channel after performing beamforming). In these cases, a receive signal by the UE 115-b for the two TRPs 305 may be given by Equation 9:

y(x)=w(p₁H₁f₁+p₂H₂f₂)x+n (9)

in which y is the signal, w is a beamforming parameter associated with the UE 115-b, n is a constant representing additive noise, p. is a coefficient (e.g., a coherent joint transmission coefficient), H is a channel, and f is a transmit beam, where the subscripts 1 and 2 correspond to the TRP 305-a and the TRP 305-b, respectively.

In some examples, the network entity 105-b may select combining weights (e.g., optimal or appropriate weights) for precoding 310 the TRP 305-a and the TRP 305-b for a coherent joint transmission. For example, for analog precoding 325, the UE 115-b or the network entity 105-b may select transmit beams (e.g., f) via beam management for each TRP 305 (e.g., of m total TRPs 305) involved in the joint transmission. For example, a beam fₐ may be selected for the TRP 305-a and a beam f_{b} may be selected for the TRP 305-b. For digital precoding 330, coherent joint transmission coefficients (e.g., p) may be selected via a CSI framework conditioned on selected CSI-RS resource indicators (CRIs) for each TRP 305 (e.g., of m total TRPs 305) involved in the joint transmission. For example, a coherent joint transmission coefficient pₐ may be selected for the TRP 305-a and a coherent joint transmission coefficient p_{b} may be selected for the TRP 305-b.

In some examples, the UE 115-b may select the combining weights (e.g., preferred combining weights) and transmit an indication of the combining weights to the network entity 105-b (e.g., in a CSI report) to request that the network entity 105-b uses the combining weights for a joint transmission. For example, the UE 115-b may select transmit beams and coherent joint transmission coefficients for the TRP 305-a and the TRP 305-b. In some examples, the network entity 105-b may perform the precoding 310 (e.g., the analog precoding 325 and the digital precoding 330) for the TRP 305-a and the TRP 305-b based on the indication (e.g., request) received from the UE 115-b containing one or more combining weights selected by the UE 115-b.

In some cases, the UE 115-b may select the combining weights in accordance with some criteria. For example, the UE 115-b may be aiming to increase throughput, meet an enhanced mobility (e.g., enhanced mobile broadband (eMBB)) requirement, or support URLLC, and the UE 115-b may select the coherent joint transmission weights accordingly.

In some cases, such as when the UE 115-b is selecting coherent joint transmission combining weights to improve throughput, the selected (e.g., preferred, optimal, or appropriate) coherent joint transmission combining weights may be a function of the total power constraint (e.g., s), a per-link RSRP (e.g., r₁ and r₂ for two links), and a co-phasing angle (e.g., θ, an optimal or appropriate phasing angle). For example, a coherent joint transmission coefficient (e.g., an optimal or appropriate coefficient) for the TRP 305-a may be given by Equation 10:

$${p}_{1}^{*} = \sqrt{s \frac{{r}_{1}}{{r}_{1} + {r}_{2}}} \qquad ( 10 )$$

where r₁ represents an RSRP for a link between the UE and the TRP 305-a, r₂ represents an RSRP for a link between the UE 115-b and the TRP 305-b, and s is the total power constraint at the network entity. Similarly, a coherent joint transmission coefficient (e.g., an optimal or appropriate coefficient) for the TRP 305-b may be given by Equation 11:

$${p}_{2}^{*} = \sqrt{s \frac{{r}_{2}}{{r}_{1} + {r}_{2}}} {e}^{j θ} \qquad ( 11 )$$

where θ represents a co-phasing angle (e.g., an optimal or appropriate phasing angle, which may represent a phase of the complex channel after performing beamforming).

In some cases, the network entity 105-b may be subject to a power constraint per TRP 305 (e.g., in addition to or instead of a total power constraint). For example, the power constraint may be described by Equation 12:

|pₖ|²≤sₖ (12)

where pₖ represents a coefficient (e.g., a coherent joint transmission coefficient) associated with a TCI-k corresponding to a TRP 305 with index k, and where sₖ corresponds to the power constraint per TRP 305.

In some cases where the network entity is subject to both a total power constraint and one or more power constraints per TRP 305, coherent joint transmission weights (e.g., optimal or appropriate weights) may be based on whether the sum of the power constraints per TRP 305 for each TRP 305 are greater than or less than the total power constraint. For example, if the sum of the power constraints per TRP 305 for each TRP 305 is less than or equal to the total power constraint (e.g., Σₖ sₖ≤s), a coefficient (e.g., an optimal or appropriate coherent joint transmission coefficient) for the TRP 305-a may be given by Equation 13:

p₁*=\sqrt{s₁} (13)

where s₁ represents a power constraint for the TRP 305-a. Similarly, a coefficient (e.g., an optimal or appropriate coherent joint transmission coefficient) for the TRP 305-b may be given by Equation 14:

$${p}_{2}^{*} = \sqrt{{s}_{2}} {e}^{j θ} \qquad ( 14 )$$

where s₂ represents a power constraint for the TRP 305-b (e.g., which may be the same as s₁), and where θ represents a co-phasing angle (e.g., an optimal or appropriate co-phasing angle, related to the orientation of the UE 115-b to the network entity or the TRP 305-b).

In other examples, if the sum of the power constraints per TRP 305 for each TRP 305 is greater than the total power constraint (e.g., Σₖ sₖ>s), then the coherent joint transmission coefficients (e.g., optimal or appropriate coefficients) for the TRP 305-a and the TRP 305-b may be based on a rate region. That is the coefficients may depend on the total power constraint, each of the power constraints per TRP 305, and an RSRP for a link between each of the TRPs 305 and the UE 115-b.

In accordance with examples as described herein, the network entity 105-b may transmit an indication to the UE 115-b of one or more power constraints applicable to the network entity 105-b. For example, the network entity may indicate the UE 115-b of a maximum power limit per TRP 305, an average power limit over a set of TRPs 305, a total (e.g., sum) power limit over a set of TRPs 305, a limit to a ratio between parameters selected by the UE 115-b, another power constraint, or a combination thereof. The UE 115-b may select one or more parameters (e.g., coherent joint transmission weights) in accordance with the indicated one or more power constraints and based on measurements performed by the UE 115-b. The UE 115-b may report (e.g., in a channel state information (CSI) report) the one or more parameters to the network entity 105-b (e.g., as precoding matrix indicators (PMIs)). In some examples, the network entity 105-b may configure the UE 115-b with one or more codebooks that correspond to one or more power constraints of the one or more power constraints, and the UE 115-b may determine the one or more parameters for one or more of the codebooks. The UE 115-b may transmit the report to the network entity 105-b including one or more of the codebooks, which may indicate the one or more parameters selected according to the indicated one or more power constraints.

Accordingly, the UE 115-b may determine one or more precoding parameters in accordance with the one or more power constraints applicable to the network entity 105-b. Thus, the UE 115-b and the network entity 105-b may avoid precoding parameters that cause a violation of the one or more power constraints applicable to the network entity 105-b, for example, which may decrease latency and improve connection stability at the UE 115-b.

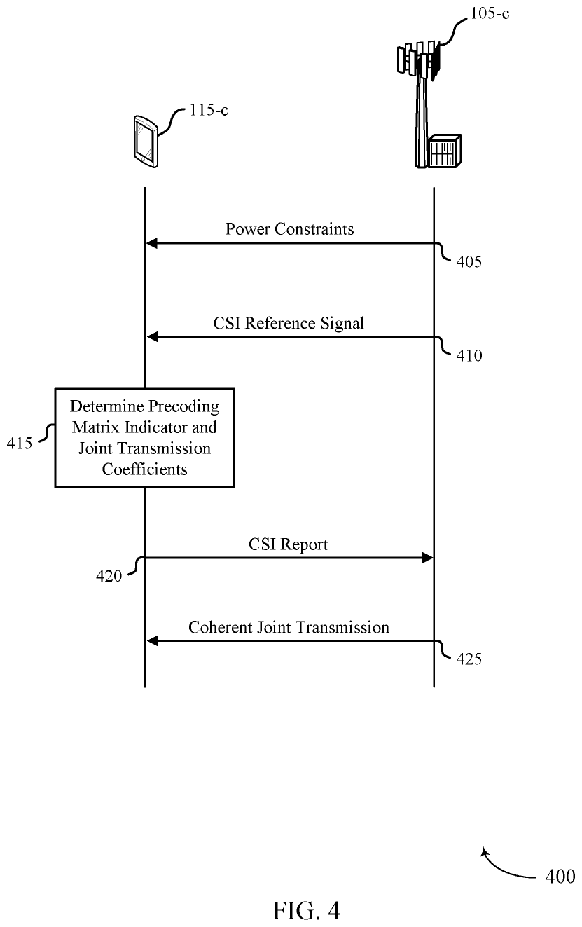

FIG. 4 illustrates an example of a process flow 400 that supports power constraint aware CSI feedback for coherent joint transmission in accordance with one or more aspects of the present disclosure. The process flow 400 may be implemented in a wireless communications system 100, a wireless communications system 200, or a wireless communications system 300 as described herein, with reference to FIGS. 1 through 3. For example, the process flow illustrates communications between a UE 115-c and a network entity 105-c, which may be examples of corresponding devices as described herein, with reference to FIGS. 1 through 3.

At 405, the network entity 105-c may transmit a message containing an indication of a set of one or more power constraints applicable to the network entity 105-c. For example, the network entity 105-c may indicate the UE 115-c of a power limit per TRP, an average power limit for an individual TRP or per each TRP, a total power limit (e.g., for all TRPs), a limit between a highest coherent joint transmission coefficient

$$( e . g . , {max}_{k} {\vert {p}_{k} \vert}^{2}$$

where pₖ is a coefficient for a TRP with index k) and an average coefficient (e.g., average |pₖ|²), or a combination thereof. In some cases, the one or more power constraints may be based on (e.g., valid for) a time duration (e.g., a quantity of slots), a bandwidth, or a spatial domain.

At 410, the network entity 105-c may transmit a CSI-RS to the UE 115-c, and the UE 115-c may measure the CSI-RS to obtain channel measurements (e.g., RSRP). In some examples, the network entity 105-c may transmit a CSI-RS from one or more TRPs associated with the network entity 105-c. For example, the network entity 105-c may transmit one or more CSI-RSs to the UE 115-c from each TRP associated with a coherent joint transmission to the UE 115-c.

At 415, The UE 115-c may select precoding parameters (e.g., coherent joint transmission parameters) in accordance with the one or more power constraints and based on, for example, channel measurements performed on the one or more CSI-RSs. In some examples, the UE 115-c may select precoders associated with one or more of the codebooks configured to the UE 115-c. The one or more codebooks may be associated with one or more of the power constraints indicated by the network entity 105-c. In some cases, the network entity 105-a may transmit an indication of one or more of the codebooks, and the UE 115-a may select precoder parameters for the one or more indicated codebooks. The selection of the precoding parameters is described in more detail herein, with reference to FIGS. 2 and 3.

At 420, the UE 115-c may transmit a CSI report indicating the one or more precoder parameters. In some examples, the UE 115-c may report the one or more precoder parameters as PMIs. Additionally, or alternatively, the UE 115-c may transmit a CSI report indicating one or more codebooks for the one or more coherent joint transmissions to be received at the UE 115-c, and the one or more codebooks may indicate the one or more precoder parameters selected in accordance with the one or more power constraints. In some cases, the UE 115-c may transmit the CSI report indicating one or more precoder parameters associated with one or more indicated power constraints. For example, the CSI report 225 may indicate one or more codebooks (e.g., that indicate one or more precoder parameters) associated with power constraints 215 that were indicated as active (e.g., in a current time or slot, bandwidth, or spatial domain) by the network entity 105-c.

At 425, the network entity 105-c may transmit a coherent joint transmission to the UE 115-c. In some examples, the network entity 105-c may transmit the coherent joint based on the one or more precoder parameters indicated in the CSI report. For example, the network entity 105-c may transmit the coherent joint transmission in accordance with the PMIs indicated by the UE 115-c. Additionally, or alternatively, the network entity 105-c may transmit the coherent joint transmission in accordance with the one or more codebooks indicated by the UE 115-c.

Accordingly, the UE 115-c may determine one or more precoding parameters in accordance with the one or more power constraints 215 applicable to the network entity 105. Thus, the UE 115-c and the network entity 105-c may avoid precoding parameters that cause a violation of the one or more power constraints 215 applicable to the network entity 105-c, for example, which may decrease latency and improve connection stability at the UE 115-c.

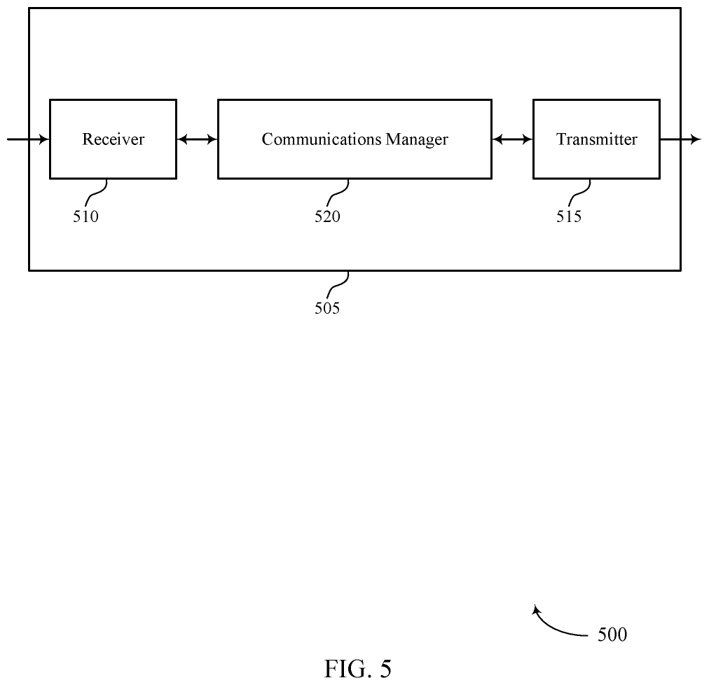

FIG. 5 illustrates a block diagram 500 of a device 505 that supports power constraint aware CSI feedback for coherent joint transmission in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to power constraint aware CSI feedback for coherent joint transmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power constraint aware CSI feedback for coherent joint transmission). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of power constraint aware CSI feedback for coherent joint transmission as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510. The communications manager 520 may send information to the transmitter 515. The communications manager 520 may be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving an indication of a set of one or more power constraints applicable to a network entity. The communications manager 520 may be configured as or otherwise support a means for receiving a CSI reference signal associated with one or more TRPs of the network entity. The communications manager 520 may be configured as or otherwise support a means for transmitting, to the network entity, a CSI report indicating a set of one or more codebooks for one or more coherent joint transmissions received at the UE in accordance with the set of one or more power constraints.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for coherent joint transmissions with reduced processing and more efficient utilization of communication resources.

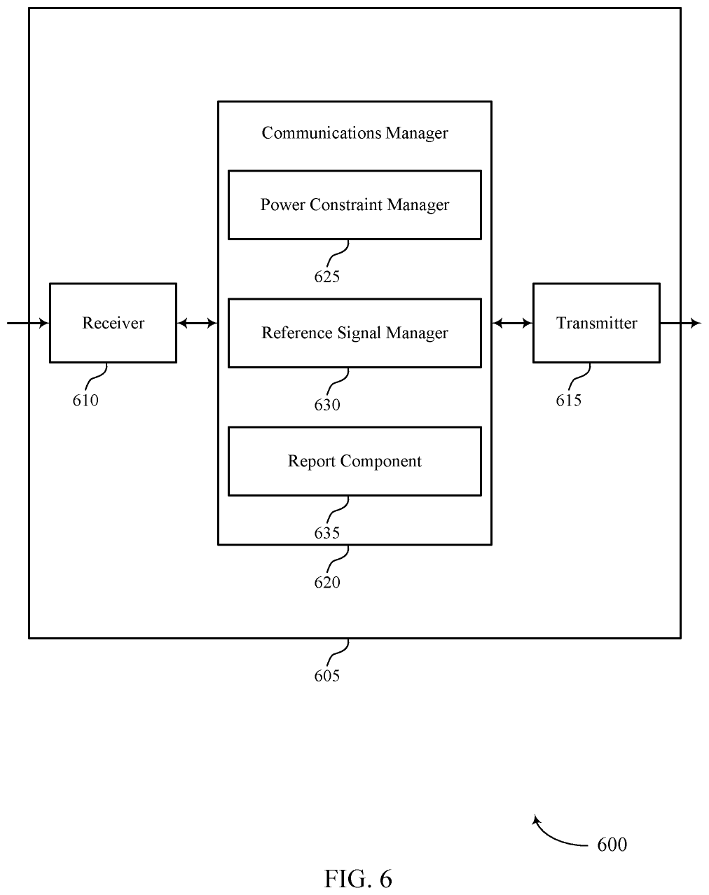

FIG. 6 illustrates a block diagram 600 of a device 605 that supports power constraint aware CSI feedback for coherent joint transmission in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to power constraint aware CSI feedback for coherent joint transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power constraint aware CSI feedback for coherent joint transmission). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of power constraint aware CSI feedback for coherent joint transmission as described herein. For example, the communications manager 620 may include a power constraint manager 625, a reference signal manager 630, a report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610. The communications manager 620 may send information to the transmitter 615. The communications manager 620 may be integrated in combination with the receiver 610, the transmitter 615, or both to obtain information, output information, or perform various other operations as described herein.

The communications manager 620 may support wireless communication at a UE in accordance with examples as disclosed herein. The power constraint manager 625 may be configured as or otherwise support a means for receiving an indication of a set of one or more power constraints applicable to a network entity. The reference signal manager 630 may be configured as or otherwise support a means for receiving a CSI reference signal associated with one or more TRPs of the network entity. The report component 635 may be configured as or otherwise support a means for transmitting, to the network entity, a CSI report indicating a set of one or more codebooks for one or more coherent joint transmissions received at the UE in accordance with the set of one or more power constraints.

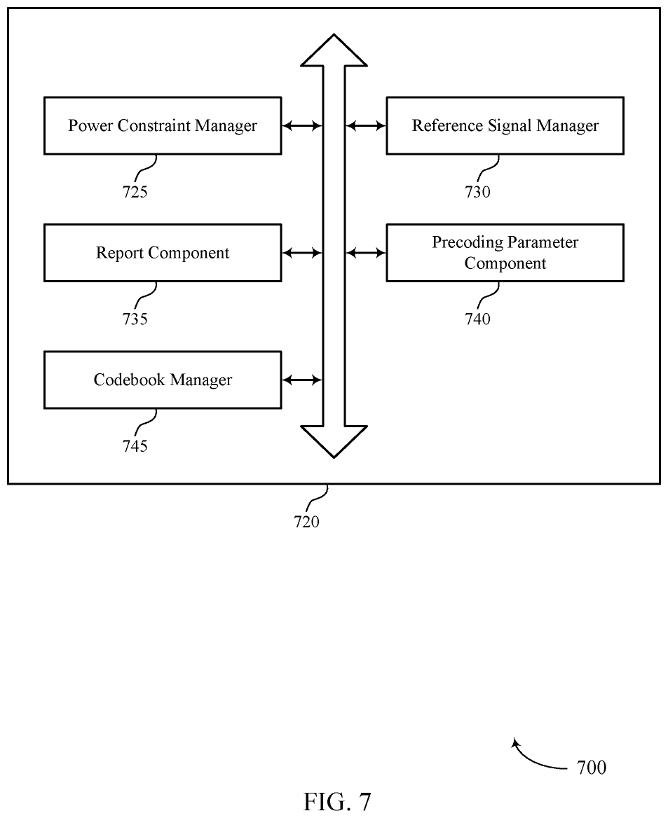

FIG. 7 illustrates a block diagram 700 of a communications manager 720 that supports power constraint aware CSI feedback for coherent joint transmission in accordance with one or more aspects of the present disclosure. The communications manager 720 may be an example of aspects of a communications manager 520, a communications manager 620, or both, as described herein. The communications manager 720, or various components thereof, may be an example of means for performing various aspects of power constraint aware CSI feedback for coherent joint transmission as described herein. For example, the communications manager 720 may include a power constraint manager 725, a reference signal manager 730, a report component 735, a precoding parameter component 740, a codebook manager 745, or any combination thereof. Each of these components may communicate, directly or indirectly, with one another (e.g., via one or more buses).

The communications manager 720 may support wireless communication at a UE in accordance with examples as disclosed herein. The power constraint manager 725 may be configured as or otherwise support a means for receiving an indication of a set of one or more power constraints applicable to a network entity. The reference signal manager 730 may be configured as or otherwise support a means for receiving a CSI reference signal associated with one or more TRPs of the network entity. The report component 735 may be configured as or otherwise support a means for transmitting, to the network entity, a CSI report indicating a set of one or more codebooks for one or more coherent joint transmissions received at the UE in accordance with the set of one or more power constraints.

In some examples, the precoding parameter component 740 may be configured as or otherwise support a means for selecting a set of multiple precoding parameters associated with the set of one or more power constraints, where the set of one or more codebooks indicates the set of multiple precoding parameters.

In some examples, to support receiving the CSI reference signal, the reference signal manager 730 may be configured as or otherwise support a means for measuring the CSI reference signal, where selecting the set of multiple precoding parameters is in accordance with the measuring.

In some examples, the precoding parameter component 740 may be configured as or otherwise support a means for generating a set of multiple coherent joint transmission precoding parameters corresponding to each power constraint of the set of one or more power constraints, where the set of multiple precoding parameters includes the set of multiple coherent joint transmission precoding parameters.

In some examples, the set of one or more power constraints indicates at least one of a power limit per TRP, an average power limit for the one or more TRPs, or a total power limit for the one or more TRPs.

In some examples, the codebook manager 745 may be configured as or otherwise support a means for receiving a message indicating a power constraint of the set of one or more power constraints, where the set of one or more codebooks includes a codebook associated with the power constraint based on the message indicating the power constraint.

In some examples, the set of one or more power constraints is associated with a time duration, a bandwidth, a spatial domain, or any combination thereof.

In some examples, the set of one or more power constraints is associated with a cell, a bandwidth part, one or more resources, a SSB, a TRP, one or more transmission configuration indicators, or any combination thereof.

In some examples, the codebook manager 745 may be configured as or otherwise support a means for receiving an indication of the set of one or more codebooks, each codebook of the set of one or more codebooks associated with a respective power constraint of the set of one or more power constraints, where transmitting the CSI report is based on receiving the indication of the set of one or more codebooks.

In some examples, the power constraint manager 725 may be configured as or otherwise support a means for receiving a medium access control-control message indicating the set of one or more power constraints and one or more activation signals for the UE.

In some examples, the one or more activation signals indicate an activation of one or more transmission configuration indicator states, one or more resources, one or more component carriers, or a combination thereof.

In some examples, the power constraint manager 725 may be configured as or otherwise support a means for receiving, from the network entity, a DCI message indicating the set of one or more power constraints.

In some examples, the DCI message is associated with an aperiodic reference signal, an aperiodic CSI report, a dynamic grant, or a beam indication.

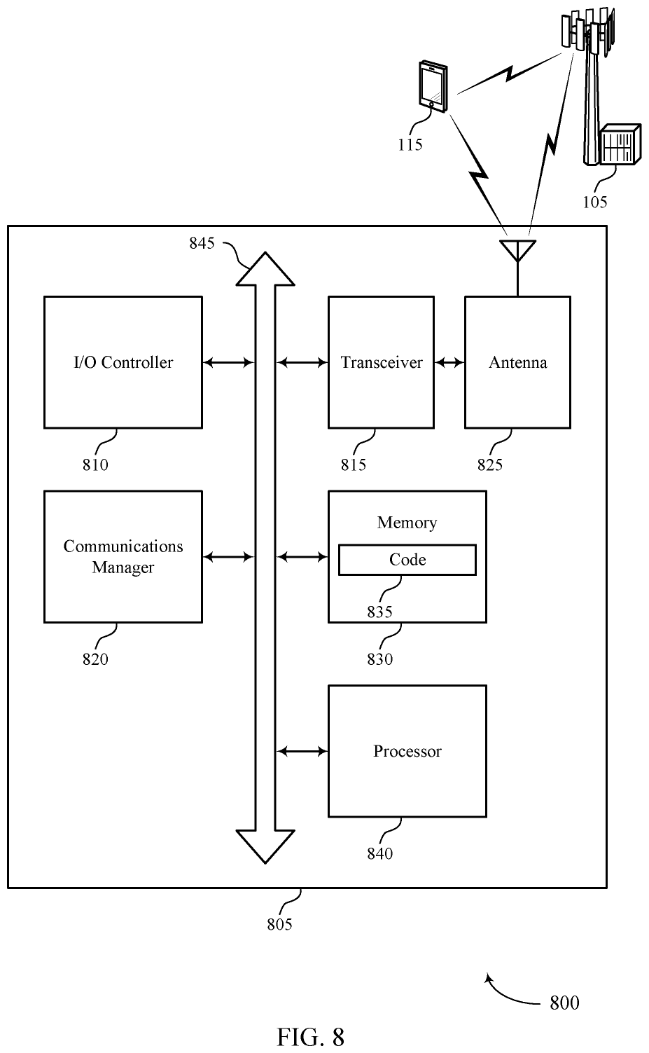

FIG. 8 illustrates a diagram of a system 800 including a device 805 that supports power constraint aware CSI feedback for coherent joint transmission in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting power constraint aware CSI feedback for coherent joint transmission). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving an indication of a set of one or more power constraints applicable to a network entity. The communications manager 820 may be configured as or otherwise support a means for receiving a CSI reference signal associated with one or more TRPs of the network entity. The communications manager 820 may be configured as or otherwise support a means for transmitting, to the network entity, a CSI report indicating a set of one or more codebooks for one or more coherent joint transmissions received at the UE in accordance with the set of one or more power constraints.

By including or configuring the communications manager 820 in accordance with examples as described herein, the device 805 may support techniques for coherent joint transmissions with improved communication reliability and reduced latency.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of power constraint aware CSI feedback for coherent joint transmission as described herein, or the processor 840 and the memory 830 may be otherwise configured to perform or support such operations.

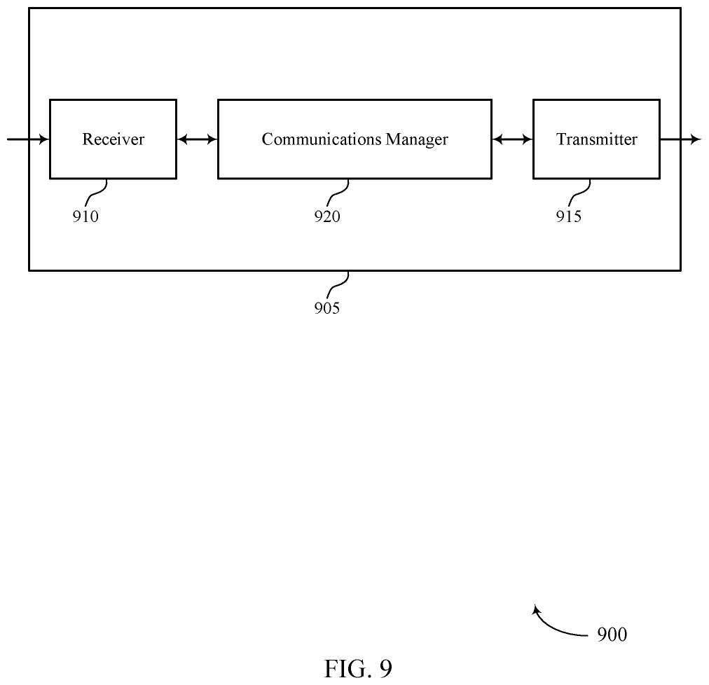

FIG. 9 illustrates a block diagram 900 of a device 905 that supports power constraint aware CSI feedback for coherent joint transmission in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of power constraint aware CSI feedback for coherent joint transmission as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting, to a UE, an indication of a set of one or more power constraints applicable to the network entity. The communications manager 920 may be configured as or otherwise support a means for transmitting a CSI reference signal associated with one or more TRPs of the network entity. The communications manager 920 may be configured as or otherwise support a means for receiving, from the UE, a CSI report indicating a set of one or more codebooks for one or more coherent joint transmissions associated with the UE in accordance with the set of one or more power constraints.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for coherent joint transmissions with reduced processing and more efficient utilization of communication resources.

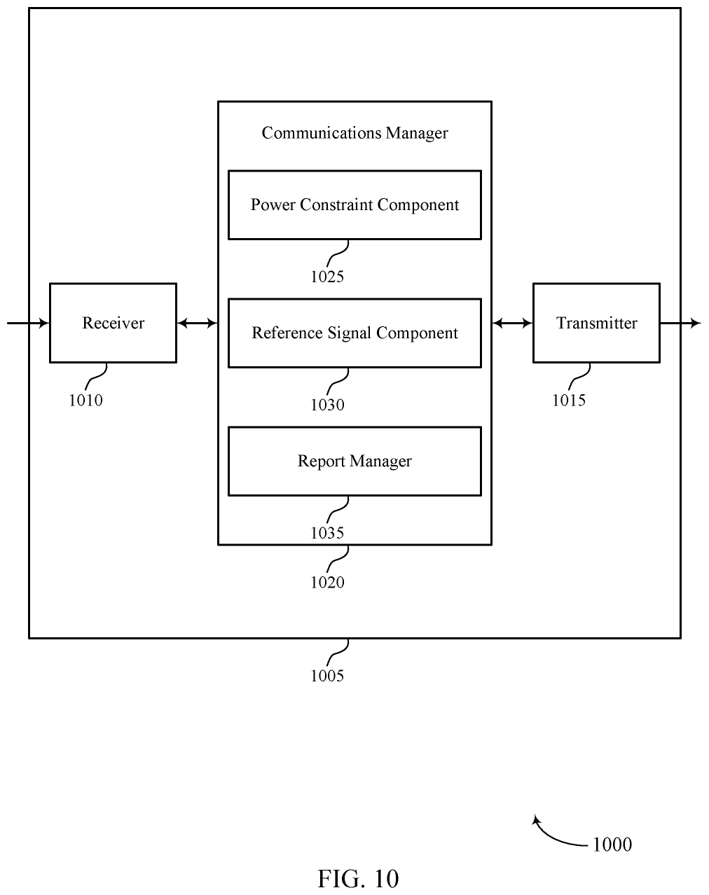

FIG. 10 illustrates a block diagram 1000 of a device 1005 that supports power constraint aware CSI feedback for coherent joint transmission in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of power constraint aware CSI feedback for coherent joint transmission as described herein. For example, the communications manager 1020 may include a power constraint component 1025, a reference signal component 1030, a report manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The power constraint component 1025 may be configured as or otherwise support a means for transmitting, to a UE, an indication of a set of one or more power constraints applicable to the network entity. The reference signal component 1030 may be configured as or otherwise support a means for transmitting a CSI reference signal associated with one or more TRPs of the network entity. The report manager 1035 may be configured as or otherwise support a means for receiving, from the UE, a CSI report indicating a set of one or more codebooks for one or more coherent joint transmissions associated with the UE in accordance with the set of one or more power constraints.

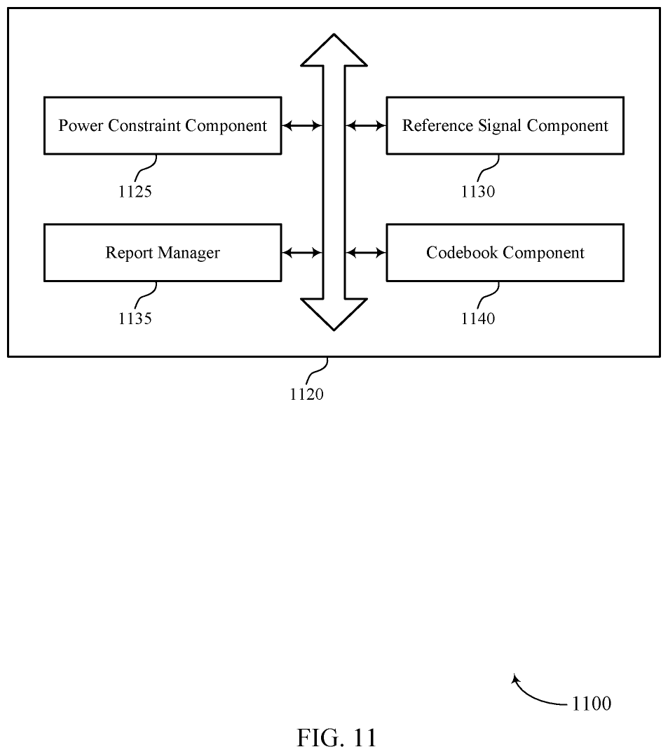

FIG. 11 illustrates a block diagram 1100 of a communications manager 1120 that supports power constraint aware CSI feedback for coherent joint transmission in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of power constraint aware CSI feedback for coherent joint transmission as described herein. For example, the communications manager 1120 may include a power constraint component 1125, a reference signal component 1130, a report manager 1135, a codebook component 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The power constraint component 1125 may be configured as or otherwise support a means for transmitting, to a UE, an indication of a set of one or more power constraints applicable to the network entity. The reference signal component 1130 may be configured as or otherwise support a means for transmitting a CSI reference signal associated with one or more TRPs of the network entity. The report manager 1135 may be configured as or otherwise support a means for receiving, from the UE, a CSI report indicating a set of one or more codebooks for one or more coherent joint transmissions associated with the UE in accordance with the set of one or more power constraints.

In some examples, the set of one or more codebooks indicates a set of multiple coherent joint transmission precoding parameters.

In some examples, a power limit per TRP, an average power limit for the one or more TRPs, or a total power limit for the one or more TRPs.

In some examples, the codebook component 1140 may be configured as or otherwise support a means for transmitting, to the UE, a message indicating a power constraint of the set of one or more power constraints, where the set of one or more codebooks includes a codebook associated with the power constraint based on the message indicating the power constraint.

In some examples, the codebook component 1140 may be configured as or otherwise support a means for transmitting an indication of the set of one or more codebooks, each codebook of the set of one or more codebooks associated with a respective power constraint of the set of one or more power constraints, where transmitting the CSI report is based on transmitting the indication of the set of one or more codebooks.

In some examples, the power constraint component 1125 may be configured as or otherwise support a means for transmitting a medium access control-control message indicating the set of one or more power constraints and one or more activation signals for the UE.

In some examples, the one or more activation signals indicate an activation of one or more transmission configuration indicator states, one or more resources, one or more component carriers, or a combination thereof.

In some examples, the power constraint component 1125 may be configured as or otherwise support a means for transmitting, to the UE, a DCI message indicating the set of one or more power constraints.

In some examples, the DCI message is associated with an aperiodic reference signal, an aperiodic CSI report, a dynamic grant, or a beam indication.

In some examples, the set of one or more power constraints are associated with a time duration, a bandwidth, a spatial domain, or any combination thereof.

In some examples, the set of one or more power constraints is associated with a cell, a bandwidth part, one or more resources, a SSB, a TRP, one or more transmission configuration indicators, or any combination thereof.

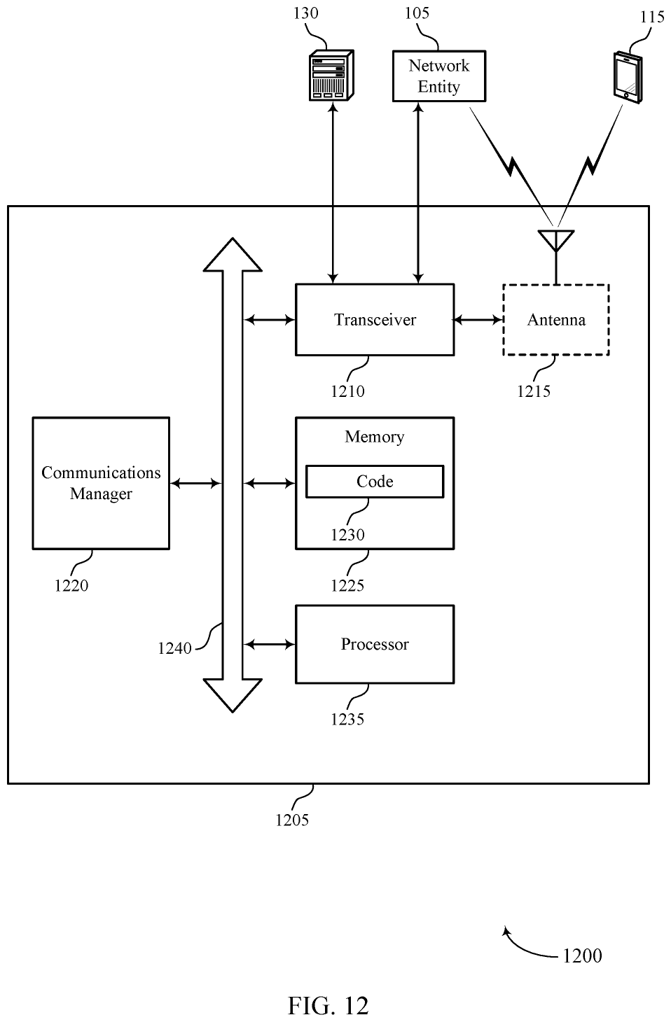

FIG. 12 illustrates a diagram of a system 1200 including a device 1205 that supports power constraint aware CSI feedback for coherent joint transmission in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting power constraint aware CSI feedback for coherent joint transmission). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting, to a UE, an indication of a set of one or more power constraints applicable to the network entity. The communications manager 1220 may be configured as or otherwise support a means for transmitting a CSI reference signal associated with one or more TRPs of the network entity. The communications manager 1220 may be configured as or otherwise support a means for receiving, from the UE, a CSI report indicating a set of one or more codebooks for one or more coherent joint transmissions associated with the UE in accordance with the set of one or more power constraints.

By including or configuring the communications manager 1220 in accordance with examples as described herein, the device 1205 may support techniques for coherent joint transmissions with improved communication reliability and reduced latency.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of power constraint aware CSI feedback for coherent joint transmission as described herein, or the processor 1235 and the memory 1225 may be otherwise configured to perform or support such operations.

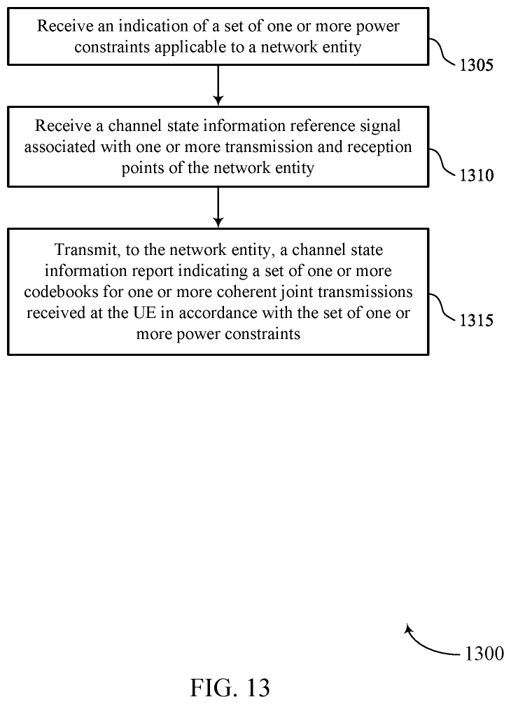

FIG. 13 illustrates a flowchart illustrating a method 1300 that supports power constraint aware CSI feedback for coherent joint transmission in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a set of one or more power constraints applicable to a network entity. The operations of 1305 may be performed in accordance with examples as disclosed herein. In some examples, aspects of the operations of 1305 may be performed by a power constraint manager 725 as described with reference to FIG. 7.

At 1310, the method may include receiving a CSI reference signal associated with one or more TRPs of the network entity. The operations of 1310 may be performed in accordance with examples as disclosed herein. In some examples, aspects of the operations of 1310 may be performed by a reference signal manager 730 as described with reference to FIG. 7.

At 1315, the method may include transmitting, to the network entity, a CSI report indicating a set of one or more codebooks for one or more coherent joint transmissions received at the UE in accordance with the set of one or more power constraints. The operations of 1315 may be performed in accordance with examples as disclosed herein. In some examples, aspects of the operations of 1315 may be performed by a report component 735 as described with reference to FIG. 7.

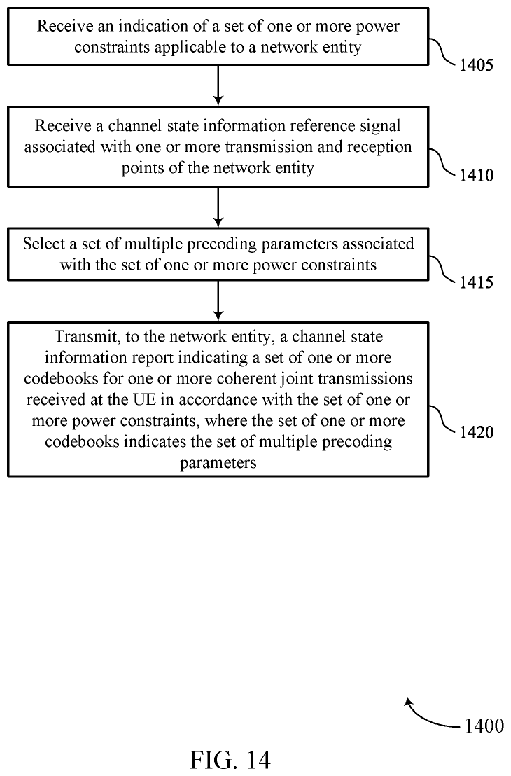

FIG. 14 illustrates a flowchart illustrating a method 1400 that supports power constraint aware CSI feedback for coherent joint transmission in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a set of one or more power constraints applicable to a network entity. The operations of 1405 may be performed in accordance with examples as disclosed herein. In some examples, aspects of the operations of 1405 may be performed by a power constraint manager 725 as described with reference to FIG. 7.

At 1410, the method may include receiving a CSI reference signal associated with one or more TRPs of the network entity. The operations of 1410 may be performed in accordance with examples as disclosed herein. In some examples, aspects of the operations of 1410 may be performed by a reference signal manager 730 as described with reference to FIG. 7.

At 1415, the method may include selecting a set of multiple precoding parameters associated with the set of one or more power constraints The operations of 1415 may be performed in accordance with examples as disclosed herein. In some examples, aspects of the operations of 1415 may be performed by a precoding parameter component 740 as described with reference to FIG. 7.

At 1420, the method may include transmitting, to the network entity, a CSI report indicating a set of one or more codebooks for one or more coherent joint transmissions received at the UE in accordance with the set of one or more power constraints, where the set of one or more codebooks indicates the set of multiple precoding parameters. The operations of 1420 may be performed in accordance with examples as disclosed herein. In some examples, aspects of the operations of 1420 may be performed by a report component 735 as described with reference to FIG. 7.

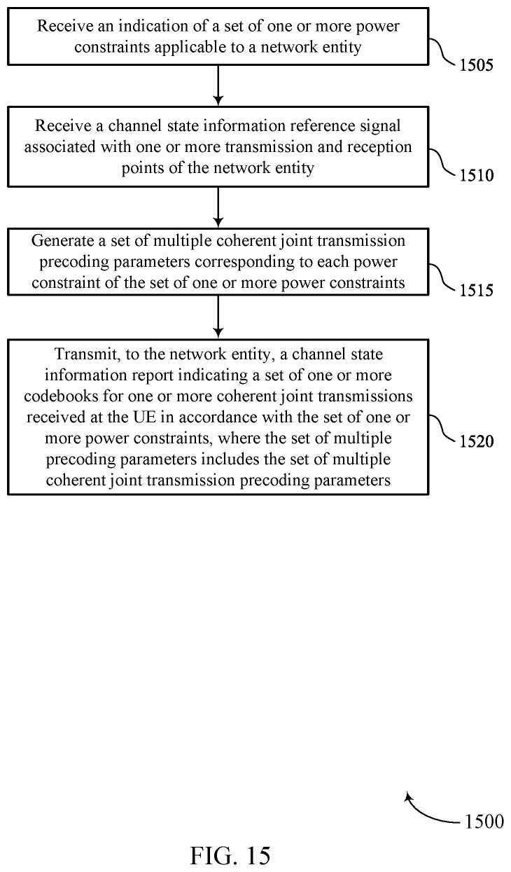

FIG. 15 illustrates a flowchart illustrating a method 1500 that supports power constraint aware CSI feedback for coherent joint transmission in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a set of one or more power constraints applicable to a network entity. The operations of 1505 may be performed in accordance with examples as disclosed herein. In some examples, aspects of the operations of 1505 may be performed by a power constraint manager 725 as described with reference to FIG. 7.

At 1510, the method may include receiving a CSI reference signal associated with one or more TRPs of the network entity. The operations of 1510 may be performed in accordance with examples as disclosed herein. In some examples, aspects of the operations of 1510 may be performed by a reference signal manager 730 as described with reference to FIG. 7.

At 1515, the method may include generating a set of multiple coherent joint transmission precoding parameters corresponding to each power constraint of the set of one or more power constraints. The operations of 1515 may be performed in accordance with examples as disclosed herein. In some examples, aspects of the operations of 1515 may be performed by a precoding parameter component 740 as described with reference to FIG. 7.

At 1520, the method may include transmitting, to the network entity, a CSI report indicating a set of one or more codebooks for one or more coherent joint transmissions received at the UE in accordance with the set of one or more power constraints, where the set of multiple precoding parameters includes the set of multiple coherent joint transmission precoding parameters. The operations of 1520 may be performed in accordance with examples as disclosed herein. In some examples, aspects of the operations of 1520 may be performed by a report component 735 as described with reference to FIG. 7.

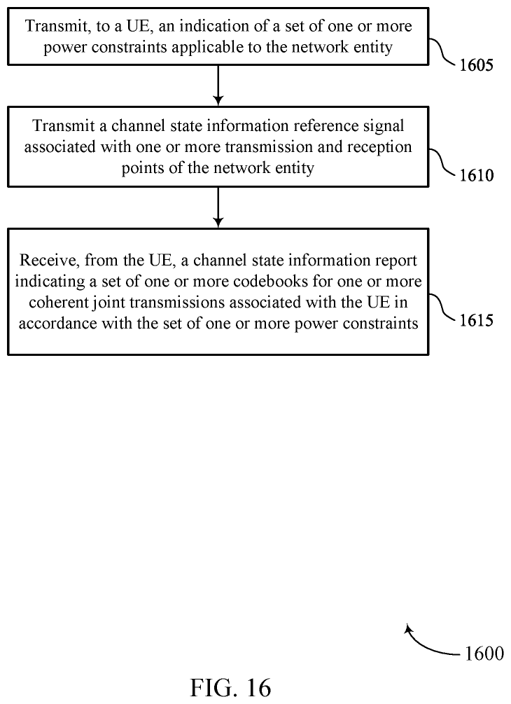

FIG. 16 illustrates a flowchart illustrating a method 1600 that supports power constraint aware CSI feedback for coherent joint transmission in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, an indication of a set of one or more power constraints applicable to the network entity. The operations of 1605 may be performed in accordance with examples as disclosed herein. In some examples, aspects of the operations of 1605 may be performed by a power constraint component 1125 as described with reference to FIG. 11.

At 1610, the method may include transmitting a CSI reference signal associated with one or more TRPs of the network entity. The operations of 1610 may be performed in accordance with examples as disclosed herein. In some examples, aspects of the operations of 1610 may be performed by a reference signal component 1130 as described with reference to FIG. 11.

At 1615, the method may include receiving, from the UE, a CSI report indicating a set of one or more codebooks for one or more coherent joint transmissions associated with the UE in accordance with the set of one or more power constraints. The operations of 1615 may be performed in accordance with examples as disclosed herein. In some examples, aspects of the operations of 1615 may be performed by a report manager 1135 as described with reference to FIG. 11.

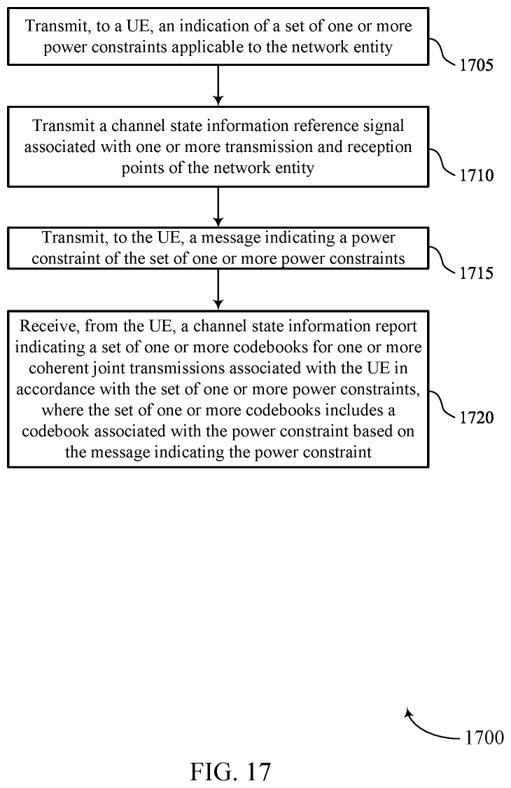

FIG. 17 illustrates a flowchart illustrating a method 1700 that supports power constraint aware CSI feedback for coherent joint transmission in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of a set of one or more power constraints applicable to the network entity. The operations of 1705 may be performed in accordance with examples as disclosed herein. In some examples, aspects of the operations of 1705 may be performed by a power constraint component 1125 as described with reference to FIG. 11.

At 1710, the method may include transmitting a CSI reference signal associated with one or more TRPs of the network entity. The operations of 1710 may be performed in accordance with examples as disclosed herein. In some examples, aspects of the operations of 1710 may be performed by a reference signal component 1130 as described with reference to FIG. 11.

At 1715, the method may include transmitting, to the UE, a message indicating a power constraint of the set of one or more power constraints. The operations of 1715 may be performed in accordance with examples as disclosed herein. In some examples, aspects of the operations of 1715 may be performed by a codebook component 1140 as described with reference to FIG. 11.

At 1720, the method may include receiving, from the UE, a CSI report indicating a set of one or more codebooks for one or more coherent joint transmissions associated with the UE in accordance with the set of one or more power constraints, where the set of one or more codebooks includes a codebook associated with the power constraint based on the message indicating the power constraint. The operations of 1720 may be performed in accordance with examples as disclosed herein. In some examples, aspects of the operations of 1720 may be performed by a report manager 1135 as described with reference to FIG. 11.

The following provides an overview of aspects of the present disclosure:

Aspect 1: A method for wireless communication at a UE, comprising: receiving an indication of a set of one or more power constraints applicable to a network entity; receiving a channel state information reference signal associated with one or more transmission and reception points of the network entity; and transmitting, to the network entity, a channel state information report indicating a set of one or more codebooks for one or more coherent joint transmissions received at the UE in accordance with the set of one or more power constraints.

Aspect 2: The method of aspect 1, further comprising: selecting a plurality of precoding parameters associated with the set of one or more power constraints, wherein the set of one or more codebooks indicates the plurality of precoding parameters.

Aspect 3: The method of aspect 2, wherein receiving the channel state information reference signal comprises: measuring the channel state information reference signal, wherein selecting the plurality of precoding parameters is in accordance with the measuring.

Aspect 4: The method of any of aspects 2 through 3, further comprising: generating a plurality of coherent joint transmission precoding parameters corresponding to each power constraint of the set of one or more power constraints, wherein the plurality of precoding parameters comprises the plurality of coherent joint transmission precoding parameters.

Aspect 5: The method of any of aspects 1 through 4, wherein the set of one or more power constraints indicates at least one of a power limit per transmission and reception point, an average power limit for the one or more transmission and reception points, or a total power limit for the one or more transmission and reception points.

Aspect 6: The method of any of aspects 1 through 5, further comprising: receiving a message indicating a power constraint of the set of one or more power constraints, wherein the set of one or more codebooks includes a codebook associated with the power constraint based at least in part on the message indicating the power constraint.

Aspect 7: The method of any of aspects 1 through 6, wherein the set of one or more power constraints is associated with a time duration, a bandwidth, a spatial domain, or any combination thereof.

Aspect 8: The method of any of aspects 1 through 7, wherein the set of one or more power constraints is associated with a cell, a bandwidth part, one or more resources, a synchronization signal block, a transmission and reception point, one or more transmission configuration indicators, or any combination thereof.

Aspect 9: The method of any of aspects 1 through 8, further comprising: receiving an indication of the set of one or more codebooks, each codebook of the set of one or more codebooks associated with a respective power constraint of the set of one or more power constraints, wherein transmitting the channel state information report is based at least in part on receiving the indication of the set of one or more codebooks.

Aspect 10: The method of any of aspects 1 through 9, further comprising: receiving a medium access control-control message indicating the set of one or more power constraints and one or more activation signals for the UE.

Aspect 11: The method of aspect 10, wherein the one or more activation signals indicate an activation of one or more transmission configuration indicator states, one or more resources, one or more component carriers, or a combination thereof.

Aspect 12: The method of any of aspects 1 through 9, further comprising: receiving, from the network entity, a downlink control information message indicating the set of one or more power constraints.

Aspect 13: The method of aspect 12, wherein the downlink control information message is associated with an aperiodic reference signal, an aperiodic channel state information report, a dynamic grant, or a beam indication.

Aspect 14: A method for wireless communication at a network entity, comprising: transmitting, to a UE, an indication of a set of one or more power constraints applicable to the network entity; transmitting a channel state information reference signal associated with one or more transmission and reception points of the network entity; and receiving, from the UE, a channel state information report indicating a set of one or more codebooks for one or more coherent joint transmissions associated with the UE in accordance with the set of one or more power constraints.

Aspect 15: The method of aspect 14, wherein the set of one or more codebooks indicates a plurality of coherent joint transmission precoding parameters.

Aspect 16: The method of any of aspects 14 through 15, wherein the set of one or more power constraints indicates at least one of a power limit per transmission and reception point, an average power limit for the one or more transmission and reception points, or a total power limit for the one or more transmission and reception points.

Aspect 17: The method of any of aspects 14 through 16, further comprising: transmitting, to the UE, a message indicating a power constraint of the set of one or more power constraints, wherein the set of one or more codebooks includes a codebook associated with the power constraint based at least in part on the message indicating the power constraint.

Aspect 18: The method of any of aspects 14 through 17, wherein further comprising: transmitting an indication of the set of one or more codebooks, each codebook of the set of one or more codebooks associated with a respective power constraint of the set of one or more power constraints, wherein transmitting the channel state information report is based at least in part on transmitting the indication of the set of one or more codebooks.

Aspect 19: The method of any of aspects 14 through 18, further comprising: transmitting a medium access control-control message indicating the set of one or more power constraints and one or more activation signals for the UE.

Aspect 20: The method of aspect 19, wherein the one or more activation signals indicate an activation of one or more transmission configuration indicator states, one or more resources, one or more component carriers, or a combination thereof.

Aspect 21: The method of any of aspects 14 through 18, further comprising: transmitting, to the UE, a downlink control information message indicating the set of one or more power constraints.

Aspect 22: The method of aspect 21, wherein the downlink control information message is associated with an aperiodic reference signal, an aperiodic channel state information report, a dynamic grant, or a beam indication.

Aspect 23: The method of any of aspects 14 through 22, wherein the set of one or more power constraints are associated with a time duration, a bandwidth, a spatial domain, or any combination thereof.

Aspect 24: The method of any of aspects 14 through 23, wherein the set of one or more power constraints is associated with a cell, a bandwidth part, one or more resources, a synchronization signal block, a transmission and reception point, one or more transmission configuration indicators, or any combination thereof.

Aspect 25: An apparatus for wireless communication at a UE, comprising a processor; memory coupled with the processor; and instructions stored in the memory and executable by the processor to cause the apparatus to perform a method of any of aspects 1 through 13.

Aspect 26: An apparatus for wireless communication at a UE, comprising at least one means for performing a method of any of aspects 1 through 13.

Aspect 27: A non-transitory computer-readable medium storing code for wireless communication at a UE, the code comprising instructions executable by a processor to perform a method of any of aspects 1 through 13.

Aspect 28: An apparatus for wireless communication at a network entity, comprising a processor; memory coupled with the processor; and instructions stored in the memory and executable by the processor to cause the apparatus to perform a method of any of aspects 14 through 24.

Aspect 29: An apparatus for wireless communication at a network entity, comprising at least one means for performing a method of any of aspects 14 through 24.

Aspect 30: A non-transitory computer-readable medium storing code for wireless communication at a network entity, the code comprising instructions executable by a processor to perform a method of any of aspects 14 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive an indication of a set of one or more power constraints applicable to a network entity;
receive a channel state information reference signal associated with one or more transmission and reception points of the network entity; and
transmit, to the network entity, a channel state information report indicating a set of one or more codebooks for one or more coherent joint transmissions received at the UE in accordance with the set of one or more power constraints.

2. The apparatus of claim 1, wherein the instructions are further executable by the processor to cause the apparatus to:
select a plurality of precoding parameters associated with the set of one or more power constraints, wherein the set of one or more codebooks indicates the plurality of precoding parameters.

3. The apparatus of claim 2, wherein the instructions to receive the channel state information reference signal are executable by the processor to cause the apparatus to:
measure the channel state information reference signal, wherein selecting the plurality of precoding parameters is in accordance with the measuring.

4. The apparatus of claim 2, wherein the instructions are further executable by the processor to cause the apparatus to:
generate a plurality of coherent joint transmission precoding parameters corresponding to each power constraint of the set of one or more power constraints, wherein the plurality of precoding parameters comprises the plurality of coherent joint transmission precoding parameters.

5. The apparatus of claim 1, wherein the set of one or more power constraints indicates at least one of a power limit per transmission and reception point, an average power limit for the one or more transmission and reception points, or a total power limit for the one or more transmission and reception points.

6. The apparatus of claim 1, wherein the instructions are further executable by the processor to cause the apparatus to:
receive a message indicating a power constraint of the set of one or more power constraints, wherein the set of one or more codebooks includes a codebook associated with the power constraint based at least in part on the message indicating the power constraint.

7. The apparatus of claim 1, wherein the set of one or more power constraints is associated with a time duration, a bandwidth, a spatial domain, or any combination thereof.

8. The apparatus of claim 1, wherein the set of one or more power constraints is associated with a cell, a bandwidth part, one or more resources, a synchronization signal block, a transmission and reception point, one or more transmission configuration indicators, or any combination thereof.

9. The apparatus of claim 1, wherein the instructions are further executable by the processor to cause the apparatus to:
receive an indication of the set of one or more codebooks, each codebook of the set of one or more codebooks associated with a respective power constraint of the set of one or more power constraints, wherein transmitting the channel state information report is based at least in part on receiving the indication of the set of one or more codebooks.

10. The apparatus of claim 1, wherein the instructions are further executable by the processor to cause the apparatus to:
receive a medium access control-control message indicating the set of one or more power constraints and one or more activation signals for the UE.

11. The apparatus of claim 10, wherein the one or more activation signals indicate an activation of one or more transmission configuration indicator states, one or more resources, one or more component carriers, or a combination thereof.

12. The apparatus of claim 1, wherein the instructions are further executable by the processor to cause the apparatus to:
receive, from the network entity, a downlink control information message indicating the set of one or more power constraints.

13. The apparatus of claim 12, wherein the downlink control information message is associated with an aperiodic reference signal, an aperiodic channel state information report, a dynamic grant, or a beam indication.

14. An apparatus for wireless communication at a network entity, comprising:
a processor;
memory coupled with the processor; and
instructions stored in the memory and executable by the processor to cause the apparatus to:
transmit, to a user equipment (UE), an indication of a set of one or more power constraints applicable to the network entity;
transmit a channel state information reference signal associated with one or more transmission and reception points of the network entity; and
receive, from the UE, a channel state information report indicating a set of one or more codebooks for one or more coherent joint transmissions associated with the UE in accordance with the set of one or more power constraints.

15. The apparatus of claim 14, wherein the set of one or more codebooks indicates a plurality of coherent joint transmission precoding parameters.

16. The apparatus of claim 14, wherein:
a power limit per transmission and reception point, an average power limit for the one or more transmission and reception points, or a total power limit for the one or more transmission and reception points.

17. The apparatus of claim 14, wherein the instructions are further executable by the processor to cause the apparatus to:
transmit, to the UE, a message indicating a power constraint of the set of one or more power constraints, wherein the set of one or more codebooks includes a codebook associated with the power constraint based at least in part on the message indicating the power constraint.

18. The apparatus of claim 14, wherein the instructions are further executable by the processor to cause the apparatus to:
transmit an indication of the set of one or more codebooks, each codebook of the set of one or more codebooks associated with a respective power constraint of the set of one or more power constraints, wherein transmitting the channel state information report is based at least in part on transmitting the indication of the set of one or more codebooks.

19. The apparatus of claim 14, wherein the instructions are further executable by the processor to cause the apparatus to:
transmit a medium access control-control message indicating the set of one or more power constraints and one or more activation signals for the UE.

20. The apparatus of claim 19, wherein the one or more activation signals indicate an activation of one or more transmission configuration indicator states, one or more resources, one or more component carriers, or a combination thereof.

21. The apparatus of claim 14, wherein the instructions are further executable by the processor to cause the apparatus to:
transmit, to the UE, a downlink control information message indicating the set of one or more power constraints.

22. The apparatus of claim 21, wherein the downlink control information message is associated with an aperiodic reference signal, an aperiodic channel state information report, a dynamic grant, or a beam indication.

23. The apparatus of claim 14, wherein the set of one or more power constraints are associated with a time duration, a bandwidth, a spatial domain, or any combination thereof.

24. The apparatus of claim 14, wherein the set of one or more power constraints is associated with a cell, a bandwidth part, one or more resources, a synchronization signal block, a transmission and reception point, one or more transmission configuration indicators, or any combination thereof.

25. A method for wireless communication at a user equipment (UE), comprising:
receiving an indication of a set of one or more power constraints applicable to a network entity;
receiving a channel state information reference signal associated with one or more transmission and reception points of the network entity; and
transmitting, to the network entity, a channel state information report indicating a set of one or more codebooks for one or more coherent joint transmissions received at the UE in accordance with the set of one or more power constraints.

26. The method of claim 25, further comprising:
selecting a plurality of precoding parameters associated with the set of one or more power constraints, wherein the set of one or more codebooks indicates the plurality of precoding parameters.

27. The method of claim 26, wherein receiving the channel state information reference signal comprises:
measuring the channel state information reference signal, wherein selecting the plurality of precoding parameters is in accordance with the measuring.

28. A method for wireless communication at a network entity, comprising:
transmitting, to a user equipment (UE), an indication of a set of one or more power constraints applicable to the network entity;
transmitting a channel state information reference signal associated with one or more transmission and reception points of the network entity; and
receiving, from the UE, a channel state information report indicating a set of one or more codebooks for one or more coherent joint transmissions associated with the UE in accordance with the set of one or more power constraints.

29. The method of claim 28, wherein the set of one or more codebooks indicates a plurality of coherent joint transmission precoding parameters.

30. The method of claim 28, wherein the set of one or more power constraints indicates at least one of a power limit per transmission and reception point, an average power limit for the one or more transmission and reception points, or a total power limit for the one or more transmission and reception points.
